(19) United States
(12) Patent Application Publication
(10) Pub. No.: US 2024/0060193 A1
(43) Pub. Date: Feb. 22, 2024

(54) Apparatus and Method for Generating and Delivering Microbubbles and Nanobubbles of Hydrogen Gas, Oxygen Gas and/or Oxyhydrogen Gas in Water

(71) Applicants: AIRXONE LIMITED, Dublin 12, Dublin, County Dublin (IE); NEW ENERGY CORPORATION LIMITED, Sofia (BG); TREELIUM S.A., Stabio (CH)

(72) Inventors: Michael HENNESSEY, Dublin 12 (IE); Paolo Lorenzo RICCARDINO, Chieri, Torino (IT); Deyan ivanov DELTCHEV, Sofia (BG); Alexandar Nikolov TZANKOV, Sofia (BG)

(21) Appl. No.: 18/269,249

(22) PCT Filed: Dec. 23, 2021
(86) PCT No.: PCT/EP2021/087554

§ 371 Date: Jun. 22, 2023

(30) Foreign Application Priority Data
Dec. 23, 2020 (EP) 20020661.3
Dec. 23, 2020 (EP) 20217140.1
Feb. 19, 2021 (EP) 21158096.4

(51) Int. Cl. C25B 1/044; C25B 9/63; C25B 15/04; C25B 15/08; C25B 9/15

(52) U.S. Cl. CPC C25B 1/044; C25B 9/63; C25B 15/04; C25B 15/08; C25B 9/15

(57) ABSTRACT

The present invention provides an apparatus and method to generate optimally sized microbubbles and/or nanobubbles of hydrogen gas, oxygen gas and/or oxyhydrogen gas according electrolysis cell parameters and voltage and/or size and/or volume of water in a water reservoir or from a flow of water. In a water reservoir a control unit is operable to control water pump means to pump water at a predetermined velocity through the electrolysis cell according to the parameters of the electrolysis cell to control the average size of the nanobubbles and/or microbubbles generated, and the water flow at the predetermined velocity shears the generated nanobubbles and/or microbubbles from the electrodes into the water flow and through the water outlet of the apparatus. In a water flow, a control unit operable to adjust voltage to the electrolysis cell, whereby the amount of the voltage adjustment is made according to the rate of flow of water and to the parameters of the electrolysis cell to control the average size of the nanobubbles and/or microbubbles generated, and wherein the flow of water shears the generated nanobubbles and/or microbubbles from the electrodes into the water flow and through a water outlet.

The present invention relates to an apparatus and method for generating and delivering nanobubbles and microbubbles of hydrogen gas, oxygen gas and/or oxyhydrogen gas in water.

Studies have demonstrated water containing dissolved hydrogen at a concentration of 0.2 ppm to 1.6 ppm (parts per million), can provide therapeutic effects to the human body, as a selective antioxidant, anti-inflammatory, anti-allergic, neuro-protective and increased cellular metabolism. Hydrogen is the smallest and lightest molecule in existence. It can penetrate bio-membranes and diffuse into the cytosol, mitochondria and nucleus of cells neutralising free radicals. Other antioxidants such as Vitamin C or Vitamin E are much larger molecules and unable to penetrate the skin and are best delivered through the digestive tract. Therefore bathing or washing in or drinking hydrogen is a novel way to deliver the therapeutic benefits o of hydrogen to the body.

Furthermore, changes in the appearance of skin is a common visible sign of aging. Typical indications of aging skin include loss of elasticity and wrinkles and is often the result of exposure to reactive oxygen species (ROS) and reactive nitrogen species (RNS) that cause damage to cellular proteins, membranes and DNA. Exposure to environmental factors, such as ultraviolet light, ionizing radiation and pollutants typically cause high ROS concentrations in skin. Damage caused by free radicals (ROS/RNS) are from cellular respiration and environmental factors such as UV light, pollution, smoking and the like.

Cosmetic interventions, such as topical creams, are often attempted to improve skin appearance, however, the effects of these treatments are temporary and do little to improve skin structure and appearance unless they deliver antioxidants to skin tissue and prevent ROS/RNS damage.

Antioxidants may however be delivered to skin and bathing in water containing molecular hydrogen gas bubbles are known to reduce oxidative stress and excess amounts of ROS/RNS in body cells due to its mild but efficient antioxidant properties. Consequently, bathing in water containing molecular hydrogen gas bubbles is used for combating oxidative damage in skin and promoting a youthful appearance.

Over 90% of the oxygen that is inhaled into the body will be consumed by the cells mitochondria to produce energy. However, during the process of oxygen consumption reactive oxygen radicals are produced, in a process of oxidation. Oxidation reduction potential (ORP), also known as REDOX, is a measurement that reflects the ability of a molecule to oxidize or reduce another molecule. Oxidation is the loss of electrons, so oxidizers accept electrons from other molecules. Reduction is the gain of electrons, so reducers donate electrons to other molecules. Oxidation reduction potential is measured as a single voltage in millivolts (mV). Oxidizers have a positive ORP value, while reducers have a negative ORP value. Regular tap water will have an ORP in the range of +200-+400. Carbonated drinks can be as high as +600, meaning they have a high oxidizing effect on the body. An orange has an ORP of approximately −150, green tea −200 and as such have good anti-oxidant properties.

For example, in one study [Kato, S., Saitoh, Y., Iwai, K. and Miwa, N. (2012) Hydrogen-Rich Electrolyzed Warm Water Represses Wrinkle Formation against UVA Ray Together with Type-1 Collagen Production and Oxidative Stress Dimishment in Fibroblasts and Cell-Injury Prevention in Keratinocytes. Journal of Photochemistry and Photobiology B, 106, 24-33.], subjects showed significant improvements in neck wrinkles after bathing daily for 3 months in in water containing molecular hydrogen gas bubbles (0.2-0.4 ppm H₂). This same study found that type-1 collagen synthesis was increased over 2-fold after 3-5 days in the H₂-enriched water samples compared to controls.

In a further study [Qinyuan Zhu, Yueshen Wu, Yongmei Li, Zihua Chen, Lanting Wang, Hao Xiong, Erhong Dai, Jianhua Wu, Bin Fan, Li Ping & Xiaoqun Luo] (published in 2018) titled, “Positive effects of hydrogen-water bathing in patients of psoriasis and parapsoriasis en plaques”. 75 patients with Psoriasis were assessed as to the severity of their skin condition based on the Psoriasis Area Severity Index (PASI) score and Visual Analog Scale (VAS). 41 psoriasis patients were assigned to treatment with hydrogen-water bathing therapy and 34 patients were assigned to the control group bathing in regular tap water. Hydrogen-water bathing was administrated through the skin by immersing the whole body in the hydrogen-water twice a week (interval of 3 days). Each bathing took 10 to 15 minutes. The dissolved hydrogen in the water had a concentration of 1.0 ppm (part per million) (for reference, the dissolved hydrogen of tap-water is less than 0.001 ppm) and with a high negative oxidation reduction potential (ORP) of −580 mV˜−650 mV (for reference, tap water: +200 mV˜+400 mV). After 8 weeks of therapy, patients treated with hydrogen rich water bathing showed a 41% reduction in skin scarring versus a 7% reduction for those who were in the control group as evaluated by both PASI and VAS scores. Patients with psoriasis and parapsoriasis en plaques who were treated with hydrogen-water bathing therapy achieved significant and rapid improvement in disease severity and quality of life.

In a study [Kyung Su YOON, Xue Zhu HUANG, Yang Suk YOON, Soo-Ki KIM, Soon Bong SONG, Byung Soo CHANG, Dong Heui KIM, and Kyu Jae LEE] (published in 2011) titled “Histological Study on the Effect of Electrolyzed Reduced Water-Bathing on UVB Radiation-Induced Skin Injury in Hairless Mice” This study shows that Electrolyzed Reduced Water (ERW)-bathing, i.e. hydrogen-rich water, significantly reduces UVB-induced skin damage through influencing pro-/anti-inflammatory cytokine balance in hairless mice. This evidence stems from histological examination such as scoring of skin injury, the epidermal thickness, dermal mast cells and ultrastructural change of corneocytes, as well as GP_{X} activity and cytokine analyses.

Devices for delivering molecular hydrogen in water typically use electrolysis assemblies in which oxygen and hydrogen gas produced at the electrodes are dissipated into the surrounding water. However, these known methods suffer from drawbacks, comprising that the bubbles formed at the electrodes typically coalesce into larger micro and macro bubbles of gas which then break off from the electrodes, float to the top of the surface of the water and burst. The average size of the bubbles produced is thus important as the larger they are the quicker they float to the surface and burst. Microbubbles having a dimension under 100 microns on the other hand will rise more slowly and implode in the water within a few minutes. Nanobubbles will remain in the water for a prolonged period of time and molecular hydrogen gas bubbles have an approximate half-life in water of 2 hours.

The average size of the gas bubbles produced is thus important as the smaller they are the longer they remain in the water, thus the concentration of hydrogen in the water is greater and the oxidation reduction potential (ORP) of the water is thus greater and remains so for longer. This has significant advantages where one needs to generate a large hydrogen PPM concentration or ORP value in a water reservoir or in a water flow device such as those used in a shower, drinking water system or irrigation system (for aquaponic farming).

US 2017/349458 A1 (LUO MINXIONG ET AL.) discloses a membrane-less water electrolysis method for increasing electrolysis efficiency. The method focuses on enabling more impurities in water to be electrolyzed to produce many electrons and conductive ions and creating good conditions to increase water electrolysis efficiency. A spacing of a gap reserved between a positive electrode and a negative electrode is designed according to a reasonable minimization principle, and the gap is less than 5 mm and more than 0 mm.

WO 2017/064967 A1 (HITACHI MAXEL) discloses a hydrogen water generating device provided with a water immersible water passage linking an inflow opening and outflow opening for water, a pump unit for generating water flow in the water passage, an electrolysis unit disposed in the water passage, and a power supply unit for supplying power to the pump unit and the electrolysis unit; the electrolysis unit has a plurality of porous electrodes disposed at fixed intervals; and the pump unit generates a water flow toward plate surfaces of the porous electrodes. The device relies on forced pressure and the position of electrodes to increase water turbulence within the device.

US 2011/084031 A1 (VAN VLI ET DAVID RITCHIE ET. AL.) discloses a system for reducing a redox active contaminant in a waste stream in a waste treatment system involve performing a unit process of the waste treatment system by contacting redox active contaminant in the waste stream with oxyhydrogen-rich gas generated on-site by an oxyhydrogen gas generator that implements water dissociation technology. The oxyhydrogen gas generator involves applying a pulsed electrical signal to a series of closely spaced electrodes that are submerged in the waste stream to produce oxyhydrogen-rich gas from a water component of the waste stream.

It is an object of the present invention to provide an apparatus and method that goes at least some way toward overcoming the above problem and/or that will provide the public and/or industry with a useful alternative.

According to the invention there is provided an apparatus for the generating and delivering nanobubbles and/or microbubbles of hydrogen gas, oxygen gas and/or oxyhydrogen gas in a water reservoir, the apparatus comprising:
a water inlet for receiving a flow of water from the water reservoir,
an electrolysis cell comprising electrodes to generate hydrogen and oxygen gas on the surfaces thereof from the water flow to form nanobubbles and/or microbubbles of hydrogen gas, oxygen gas and/or oxyhydrogen gas, in which the electrolysis cell is configured according to parameters, comprising dimensions of each electrode, number of electrodes, surface area of reaction of the electrodes, electrical resistivity of the electrodes, distance between the electrodes in the electrolysis cell and voltage applied to the electrolysis cell,
water pump means to draw water flow into the inlet through the electrolysis cell to a water outlet, and
a control unit to control the water pump means to pump water at a predetermined velocity through the electrolysis cell according to the parameters of the electrolysis cell to control the average size of the nanobubbles and/or microbubbles generated, and the water flow at the predetermined velocity shears the generated nanobubbles and/or microbubbles from the electrodes into the water flow and through the water outlet of the apparatus.

Accordingly, water flows through and along surfaces of the electrodes at a desired predetermined velocity which has been optimised for a given electrolysis cell setup according to parameters of the electrolysis cell and voltage applied to control the average size of the microbubbles and nanobubbles of hydrogen gas, oxygen gas and/or oxyhydrogen gas formed from the electrodes and to shear the optimally average sized microbubbles and nanobubbles out of the electrolysis cell to an outlet of the apparatus before they coalesce into larger micro and macro bubbles.

This provides a more efficient apparatus as the water flow at the predetermined velocity is directed between the electrodes to shear off gas bubbles at the optimally desired average size to thereby saturate water flow at the outlet with a higher concentration of microbubbles and nanobubbles of hydrogen gas, oxygen gas and/or oxyhydrogen gas.

The invention is operable to generate optimally sized microbubbles and nanobubbles according electrolysis cell parameters and voltage and/or size and/or volume of water in the water reservoir since the average size of the microbubbles and/or nanobubbles is controlled by the velocity of the water flow provided by a control unit which controls the water pump means to pump water at a predetermined velocity through the electrolysis cell. Therefore, the apparatus facilitates the generation of more and optimal microbubbles and nanobubbles of a desired size using the velocity of the water flowing through the electrolysis cell to control the average size of the bubbles sheared from the electrodes.

The benefit of the invention is in its ability to convert the water from a positive ORP value to a relatively high negative ORP value. By generating gas nanobubbles and/or microbubbles that remain in the water longer a more efficient apparatus for optimally generating water flow out of the apparatus with a lower ORP value is created.

Preferably, the flow of water from the inlet and across surfaces of the electrodes is substantially laminar.

The benefit of laminar flow is that there is less turbulence of the water and less coalescence of the bubbles, which results in more nanobubbles in the water which will remain in the water longer which maintains a desirable higher negative ORP level in the water.

Preferably, the water velocity within the electrolysis cell has range between 0.26 to 1.31 metres/second in a standard 12.5 millimetre shower pipe.

Preferably, the water velocity within the electrolysis cell has range between 0.2 to 3.0 metres/second in a standard 12.5 millimetre shower pipe.

Preferably, the electrolysis cell is configured to operate at a voltage according to the configuration of the electrodes in the electrolysis cell, comprising the dimensions of each electrode plate, the number of electrodes, the surface area of reaction of the electrolysis cell, the electrical resistivity of the electrodes used, and distance between the electrodes in the electrolysis cell.

The laminar water flow further ensures shearing of the gas bubbles occurs relatively quickly and with reduced turbulence thereby preventing the microbubbles and nanobubbles of hydrogen gas, oxygen gas and/or oxyhydrogen gas from coalescing to a larger size, which would cause them to be eventually displaced from the electrodes and to float to the top of the bath water and burst. By moving water over, across and between the electrodes at a predetermined velocity the contact time between the water and electrodes is reduced which avoids the formation of larger bubbles.

Preferably, the water inlet is narrower than the water outlet.

Preferably, the water outlet and the water inlet are in substantially the same horizontal plane of the apparatus.

Preferably, the electrolysis cell is in a cartridge, whereby the cartridge is removably connected to the apparatus.

Preferably, the electrolysis cell is removable from the cartridge.

Preferably, the electrolysis cell is removably connected to the apparatus

Preferably, the electrolysis cell is provided on an inner wall of the reservoir, and the water pump and control unit are coupled to the electrolysis cell and provided on an outer wall of the reservoir.

Preferably, the apparatus comprises a housing, and the electrodes are arranged such that the direction of flow of water from the water inlet and across surfaces of the electrodes within the housing to the water outlet is substantially laminar.

Preferably, the electrodes are provided in the electrolysis cell as an electrode stack configured to perform electrolysis on the water, in which the electrode stack is arranged between the water inlet and water outlet of the apparatus and comprises a plurality of spaced apart electrode plates disposed such that the water flows between and over the electrode plates from the water inlet to the water outlet of the apparatus.

Preferably, the electrode plates in the electrode stack are spaced between about 0.5 mm to 2 mm apart.

Preferably, the water flow at the outlet has a negative oxidative reduction potential (ORP).

Preferably, the distance between the electrode plates is 1 mm, and molecules of water flowing through the electrode housing are not more than 0.5 mm from an electrode plate, comprising at outer edges of the electrode plates and inactive outer sides of top and bottom plates in the electrode stack.

Preferably, water entry and water exit apertures are provided at ends of the electrode plates to direct the flow of water across surfaces of the electrode plates and through the electrode housing.

Preferably, the apparatus further comprises battery power means.

Preferably, the apparatus further comprises means for connection to a mains power supply.

According to the invention there is provided a method for generating and delivering nanobubbles and/or microbubbles of hydrogen gas, oxygen gas and/or oxyhydrogen gas in a water reservoir, the method comprising steps of:
receiving a flow of water from the water reservoir via a water inlet,
operating an electrolysis cell comprising electrodes to generate hydrogen and oxygen gas on the surfaces thereof from the water flow to form nanobubbles and/or microbubbles of hydrogen gas, oxygen gas and/or oxyhydrogen gas, in which the electrolysis cell is configured according to parameters, comprising dimensions of each electrode, number of electrodes, surface area of reaction of the electrodes, electrical resistivity of the electrodes, distance between the electrodes in the electrolysis cell and voltage applied to the electrolysis cell,
operating a control unit to control a water pump means to pump water at a predetermined velocity through the electrolysis cell according to the parameters of the electrolysis cell and voltage applied to the electrolysis cell to control the average size of the nanobubbles and/or microbubbles generated, and the water flow at the predetermined velocity shears the generated nanobubbles and/or microbubbles from the electrodes into the water flow and through the water outlet of the apparatus.

Preferably, the method comprises a step of arranging the electrodes with the electrolysis cell such that the flow of water from the inlet and across surfaces of the electrodes is substantially laminar.

Preferably, the method comprises a step of configuring the water inlet to be narrower than the water outlet.

Preferably, the method comprises a step of configuring water outlet and the water inlet to be in the same horizontal plane.

Preferably, the method comprises a step of providing the electrolysis cell is in a cartridge, whereby the cartridge is removably connected to the apparatus.

Preferably, the electrolysis cell is removable from the cartridge.

In a further embodiment there is provided an apparatus for generating and delivering nanobubbles and/or microbubbles of hydrogen gas, oxygen gas and/or oxyhydrogen gas in a flow of water, the apparatus comprising:
a water inlet for receiving a flow of water from a water supply,
an electrolysis cell comprising electrodes to generate hydrogen and oxygen gas on the surfaces thereof from the water flow to form nanobubbles and/or microbubbles of hydrogen gas, oxygen gas and/or oxyhydrogen gas, in which the electrolysis cell is configured according to flow rate and electrolysis cell parameters, comprising dimensions of each electrode, number of electrodes, surface area of reaction of the electrodes, electrical resistivity of the electrodes, distance between the electrodes in the electrolysis cell and voltage applied to the electrolysis cell,
a control unit operable to adjust voltage to the electrolysis cell, whereby the amount of the voltage adjustment is made according the rate of flow of water and to the parameters of the electrolysis cell to control the average size of the nanobubbles and/or microbubbles generated, and wherein the flow of water shears the generated nanobubbles and/or microbubbles from the electrodes into the water flow and through a water outlet.

According to the invention, the control unit is operable to adjust voltage to the electrolysis cell according to the rate of flow of water, and the voltage provided to the electrodes controls the average size of the nanobubbles and/or microbubbles generated for a given electrolysis cell setup. As the water flows through and along surfaces of the electrodes at the desired voltage it shears the optimally sized microbubbles and nanobubbles out of the electrolysis cell to an outlet of the apparatus.

The configuration controls the average size of the microbubbles and nanobubbles of hydrogen gas, oxygen gas and/or oxyhydrogen gas generated at the electrodes and to shear the optimally average sized microbubbles and nanobubbles out of the electrolysis cell to an outlet of the apparatus before they coalesce into larger micro and macro bubbles. This provides a more efficient apparatus as gas bubbles at the optimally desired average size are sheared off the electrodes to thereby saturate water flow at the outlet with a higher concentration of microbubbles and nanobubbles of hydrogen gas, oxygen gas and/or oxyhydrogen gas.

Preferably, flow control means determines the rate of flow of water into the apparatus via the inlet. Such flow control means may be provided with or integrated within the apparatus or may be a separate stand-alone unit capable of determining the rate of water flow at the inlet to the apparatus.

Preferably, the apparatus comprises a water drainage valve to allow water to self-drain from the electrolysis cell when the flow of water from the water supply stops.

Preferably, the water drainage valve is closed by the flow of water from the water supply through the inlet and opens when the flow of water from the water supply stops allowing water to drain from the electrolysis cell.

According to the invention there is provided a method for generating and delivering nanobubbles and/or microbubbles of hydrogen gas, oxygen gas and/or oxyhydrogen gas in a flow of water comprising:
receiving a flow of water from a water supply via a water inlet,
operating an electrolysis cell comprising electrodes to generate hydrogen and oxygen gas on the surfaces thereof from the water flow to form nanobubbles and/or microbubbles of hydrogen gas, oxygen gas and/or oxyhydrogen gas on surfaces thereof from the water flow, in which the electrolysis cell is configured according to flow rate and electrolysis cell parameters, comprising dimensions of each electrode, number of electrodes, surface area of reaction of the electrodes, electrical resistivity of the electrodes, distance between the electrodes in the electrolysis cell and voltage applied to the electrolysis cell,
operating a control unit operable to adjust voltage to the electrolysis cell, whereby the amount of the voltage adjustment is made according to the rate of flow of water and to the parameters of the electrolysis cell to control the average size of the nanobubbles and/or microbubbles generated, and wherein the flow of water shears the generated nanobubbles and/or microbubbles from the electrodes into the water flow.

Preferably, the method comprises operating flow control means to determine the rate of flow of water,

Preferably, the method comprises a step of operating a water drainage valve to allow water to drain from the electrolysis cell when the flow of water from the water supply stops.

Preferably, the method comprises a step of configuring the water drainage valve to be closed by the flow of water from the water supply through the inlet and open when the flow of water from the water supply stops allowing water to drain from the electrolysis cell.

The top and bottom plates of the electrodes are also configured not to produce any gas and are located substantially against the housing walls to prevent, where possible, water flowing over them. The side edges of the electrodes are also tightly packed against the housing wall to further ensure that all water flowing through the housing is forced over the electrode surfaces.

Any number of electrode plates may be provided, comprising 2, 3, 4, 5 or more as required or as desired. References in the following to any specific number of electrode plates is given by way of example only and should not be seen as limiting.

Preferably, the electrode plates in the electrode stack are spaced between 0.5 mm to 2 mm apart.

Preferably, the electrode plates in the electrode stack are spaced between 1 mm to 5 mm apart.

Alternatively, electrode plates are spaced substantially 1 mm, 2 mm, 3 mm, 4 mm, 5 mm or more apart.

Preferably, the electrodes are arranged so that the water flowing through the electrode stack is never more than a defined distance of between about 0.4 mm to 2 mm from an electrode as it flows through the electrode housing. This results in a greater volume of nanobubbles and sub 100 micron microbubbles of hydrogen gas, oxygen gas and/or oxyhydrogen gas in the water thus increasing the concentration of hydrogen in the water as measured in parts per million (PPM) and its corresponding ORP value.

As nanobubbles will remain in the water for extended periods of time, and often hours, this high concentration of hydrogen in the water also remains in the water for a long period of time, thus ensuring the negative ORP value remains relatively high.

It will be understood that when the distance between the electrode plates is 1 mm, the water, as it flows through the electrode cell will not be more than 0.5 mm from an electrode surface, even on the outer edges of the electrodes or at the top or bottom plates.

The electrode plate surfaces extend in the direction of movement of water through the apparatus.

Preferably, the electrode plates are solid plates. In alternative embodiments the electrode plates may be mesh plates or solid plates with holes.

Preferably, one pair or more of the electrode plates are made from an inert material such as nickel, molybdenum, platinum-coated titanium or other material with low electrical resistivity and low corrosion in water.

Platinum has the benefit that it does not oxidize on the anode, however it is a relatively expensive electrode material to use, especially when used in products that are not in continuous use. For this reason, it is preferable to use a less expensive electrode material, such nickel or molybdenum or similar material, and to replace the electrolysis cell cartridge after a period of use. Where a non-noble metal electrode is used, it is important that the electrodes do not rest in the water when not in use as overtime the electrodes will corrode. It is therefore important that there is a self-draining mechanism or means to empty water from the electrodes.

Each electrode plate in the stack is a cathode or an anode and the plates are arranged in the stack to alternate in sequential order between being a cathode plate and an anode plate.

The cathode and anodes are connected by an arrangement of holes, pins and spacers.

Alternate hole sizes are punched through the respective anode and cathode plates and a pin is inserted through the holes formed to connect the anodes together and the cathodes together. Thus, as an example, one 3.0 mm pin connects cathode plates together yet does not make any connection with the anodes as its hole size is bigger at 5 mm. The opposite then happens on the alternative side. A plastic spacer is used to keep the electrodes apart and a hole also extends through the spacers to allow the pin to connect the anodes on one side and cathodes on the other side

Preferably, water entry and exit apertures are provided between the electrode plates to direct the flow of water across surfaces of the electrode plates and through the electrolysis cell. The water entry and exit apertures are provided at ends of the electrode plates.

The water pump means connected to the electrolysis cell by a pump outlet coupling operable draw water into the inlet and to direct water flow from an outlet of the pump to the water entry apertures between the electrodes.

Preferably, the pump means is an electrically powered water pump.

Alternatively, the water pump means is a gravity feed pump.

The water pump means may thus be external to the apparatus or fully contained within the housing. For example, pressure from a mains supply may act as an effective means for pumping water into and through the electrolysis cell.

Preferably, the water reservoir is provided as a bath or a pool, such as a conventional domestic bath, a footbath, spa bath, plunge pool, swimming pool, spa bath with integrated jets or the like

Preferably, the water pump means is located in the outer housing of the apparatus.

The electrolysis cell, comprising the electrode housing may also be located in the outer housing of the apparatus.

The outer housing provides an inlet and outlet for water flow and is configured to be submersible in a water reservoir. Alternatively, the housing may be integrated or retrofitted to an existing bath, pool or other water appliance.

According to the invention there is provided a water reservoir comprising an apparatus for the generating and delivering nanobubbles and/or microbubbles of hydrogen gas, oxygen gas and/or oxyhydrogen gas, the apparatus comprising:
a water inlet for receiving a flow of water from the water reservoir,
an electrolysis cell comprising electrodes to generate hydrogen and oxygen gas on the surfaces thereof from the water flow to form nanobubbles and/or microbubbles of hydrogen gas, oxygen gas and/or oxyhydrogen gas, in which the electrolysis cell and voltage applied to the electrolysis cell is configured according to parameters, comprising dimensions of each electrode, number of electrodes, surface area of reaction of the electrodes, electrical resistivity of the electrodes, distance between the electrodes in the electrolysis cell and voltage applied to the electrolysis cell,
water pump means to draw water flow into the inlet through the electrolysis cell to a water outlet, and
a control unit to control the water pump means to pump water at a predetermined velocity through the electrolysis cell according to the parameters of the electrolysis cell to control the average size of the nanobubbles and/or microbubbles generated, and the water flow at the predetermined velocity shears the generated nanobubbles and/or microbubbles from the electrodes into the water flow and through the water outlet of the apparatus.

The apparatus further comprises:
attachment means comprising an inlet connector and an outlet connector for connecting the apparatus to a side wall of the water reservoir,
the inlet and outlet connectors each extending through spaced apart apertures in the side wall of the water reservoir, and
whereby, water from the water reservoir is drawn into the inlet of the apparatus via the inlet connector and gas bubbles displaced from the electrodes into the water flow are directed from the outlet of the apparatus and into the water in the reservoir water through the outlet connector.

Preferably, the attachment means is configured for connecting the apparatus on an external surface of the side wall of the water reservoir provided as a bath or hot tub or other reservoir.

Preferably, the apparatus comprises drainage means operable to drain water remaining in the apparatus when the water reservoir is emptied, in which the drainage means is self-draining and water flows out of the apparatus under force of gravity.

In a further embodiment there is provided a shower comprising an apparatus for generating and delivering nanobubbles and/or microbubbles of hydrogen gas, oxygen gas and/or oxyhydrogen gas in a flow of water, the apparatus comprising:
a water inlet for receiving a flow of water from a water supply,
an electrolysis cell comprising electrodes to generate hydrogen and oxygen gas on the surfaces thereof from the water flow to form nanobubbles and/or microbubbles of hydrogen gas, oxygen gas and/or oxyhydrogen gas, in which the electrolysis cell is configured according to flow rate and electrolysis cell parameters, comprising dimensions of each electrode, number of electrodes, surface area of reaction of the electrodes, electrical resistivity of the electrodes, distance between the electrodes in the electrolysis cell and voltage applied to the electrolysis cell,
a control unit operable to adjust voltage to the electrolysis cell, whereby the amount of the voltage adjustment is made according to the rate of flow of water and to the parameters of the electrolysis cell to control the average size of the nanobubbles and/or microbubbles generated, and wherein the flow of water shears the generated nanobubbles and/or microbubbles from the electrodes into the water flow and through a water outlet.

The apparatus disposed in the shower further comprises a flow control means to determine the rate of flow of water at the inlet.

The apparatus disposed in the shower further comprises attachment means comprising an inlet connector and an outlet connector for connecting the apparatus to the shower,
the inlet connector for connecting the inlet of the apparatus to a water inlet of the shower or an outlet of a heated water reservoir of the shower,
the outlet connector for connecting the outlet of the apparatus to an end of the shower hose or other outlet of the shower.

The shower may be a standard shower, a shower fitted in a bathtub, an electric shower or a power shower operable to heat water using a heated water reservoir provided between a mains water inlet and an outlet of the shower. The shower system may be provided as a portable shower system for pet washing, watering, brushing or other cleaning system.

In a further embodiment there is provided a shower head comprising an apparatus for generating and delivering nanobubbles and/or microbubbles of hydrogen gas, oxygen gas and/or oxyhydrogen gas in a flow of water, the apparatus comprising:
a water inlet for receiving a flow of water from a water supply,
an electrolysis cell comprising electrodes to generate hydrogen and oxygen gas on the surfaces thereof from the water flow to form nanobubbles and/or microbubbles of hydrogen gas, oxygen gas and/or oxyhydrogen gas, in which the electrolysis cell is configured according to flow rate and electrolysis cell parameters, comprising dimensions of each electrode, number of electrodes, surface area of reaction of the electrodes, electrical resistivity of the electrodes, distance between the electrodes in the electrolysis cell and voltage applied to the electrolysis cell,
a control unit operable to adjust voltage to the electrolysis cell, whereby the amount of the voltage adjustment is made according to the rate of flow of water and to the parameters of the electrolysis cell to control the average size of the nanobubbles and/or microbubbles generated, and wherein the flow of water shears the generated nanobubbles and/or microbubbles from the electrodes into the water flow and through a water outlet.

The apparatus disposed in the showerhead further comprising a flow control means to determine the rate of flow of water at the inlet.

The apparatus disposed in the showerhead further comprising
attachment means for connecting the apparatus within a housing of the showerhead,
an inlet connector for fluid connection of the inlet of the apparatus to a water inlet of the shower head,
whereby water flow received at the water inlet of the showerhead flows through the electrode cell to the outlet of the apparatus and through outlet holes of the showerhead.

Preferably, the attachment means is configured as a support bracket for holding the apparatus securely within the showerhead.

Preferably, the apparatus further comprises an inline flow meter to measure water flow rate into the showerhead.

Preferably, the inline flow meter is disposed at the inlet of the showerhead.

Preferably, the apparatus comprises a user interface panel operable to display parameters of the water flow, comprising one or more of: water temperature and water flow rate.

Preferably, the apparatus comprises a control unit to determine the optimum DC power output to the electrodes to generate the optimum gas output from the electrodes to provide the optimum or maximum −ORP (negative ORP) value and the lowest average gas bubble size, preferably nanobubbles. The control unit incorporates power converter means to convert supply power from AC to DC power as required. Preferably a pulsed electrical signal is supplied to the electrodes. The benefit of using a pulsed electrical signal is that it reduces corrosion on non-noble metal anodes.

The present invention may be provided as a showerhead incorporating the apparatus, or as an apparatus for a showerhead such that the apparatus within the showerhead is adapted to be periodically replaced and/or retrofitted as required or as desired.

The advantages of a showerhead adapted or incorporated within the apparatus is that as the microbubbles and nanobubbles of hydrogen gas, oxygen gas and oxyhydrogen gas are infused into the shower water reducing bubble coalescence as it flows directly out of the showerhead through the showerhead outlets/nipples onto the user.

Furthermore, it is beneficial for a user to be able to see the efficacy of the shower water as measured by the ORP value of the water by locating an ORP meter sensor means in the showerhead assembly to measure the ORP value of the water as it exits from the electrolysis cell. This ORP meter is connected to a control unit and a reading value is sent to the display on the user interface panel, which may be provide at or near the shower taps or control unit.

The inline flow meter is installed to determine the water flow through the pipes as this will be different in every installation and is dependent on water pressure in each installation. The flow meter is also connected to the control unit.

The control unit comprises an AC to DC power converter, a printed circuit board which takes inputs from the ORP meter, and optionally from the flow meter, and based on this input determines the optimum DC power output to the electrodes to generate the optimum gas output from the electrodes to provide the optimum or maximum −ORP (negative ORP) value. A pulsed electrical signal is applied to the electrodes.

In a further embodiment there is provided a potable drinking water tap, pet washing, watering, brushing or other cleaning system comprising an apparatus for generating and delivering nanobubbles and/or microbubbles of hydrogen gas, oxygen gas and/or oxyhydrogen gas in a flow of water, the apparatus comprising:
a water inlet for receiving a flow of water from a water supply,
an electrolysis cell comprising electrodes to generate hydrogen and oxygen gas on the surfaces thereof from the water flow to form nanobubbles and/or microbubbles of hydrogen gas, oxygen gas and/or oxyhydrogen gas, in which the electrolysis cell is configured according to flow rate and electrolysis cell parameters, comprising dimensions of each electrode, number of electrodes, surface area of reaction of the electrodes, electrical resistivity of the electrodes, distance between the electrodes in the electrolysis cell and voltage applied to the electrolysis cell,
a control unit operable to adjust voltage to the electrolysis cell, whereby the amount of the voltage adjustment is made according to the rate of flow of water and to the parameters of the electrolysis cell to control the average size of the nanobubbles and/or microbubbles generated, and wherein the flow of water shears the generated nanobubbles and/or microbubbles from the electrodes into the water flow and through a water outlet.

The apparatus disposed in the potable drinking water tap, pet washing, watering, brushing or other cleaning system further comprising a flow control means to determine the rate of flow of water at the inlet.

The apparatus disposed in the potable drinking water tap, pet washing, watering, brushing or other cleaning system further comprising:
attachment means comprising an inlet connector and an outlet connector for connecting the apparatus to the water tap or outlet supply,
the inlet connector for connecting the inlet of the apparatus to a water inlet of the domestic potable drinking water supply,
the outlet connector for connecting the outlet of the apparatus to a water outlet pipe,
whereby, water from the water inlet of the domestic potable drinking water supply is drawn into the inlet of the apparatus via the inlet connector and gas bubbles, comprising microbubbles and nanobubbles, displaced from the electrodes into the water flow are directed from the outlet of the apparatus and into the water flow via the water outlet pipe to an outlet tap.

The present invention may also be adapted for application to supply microbubbles and nanobubbles of hydrogen gas, oxygen gas and oxyhydrogen gas in water in other systems, comprising, but not limited to water drinking water (animals, poultry and humans), aquaponic farming, water irrigation systems, fish farming, potable drinking water tap, pet washing, watering, brushing or other cleaning systems and waste-water treatment.

Further aspects of the present invention will become apparent from the ensuing description which is given by way of example only.

The invention will be more clearly understood from the following description of some embodiments thereof, given by way of example only, with reference to the accompanying drawings, in which:

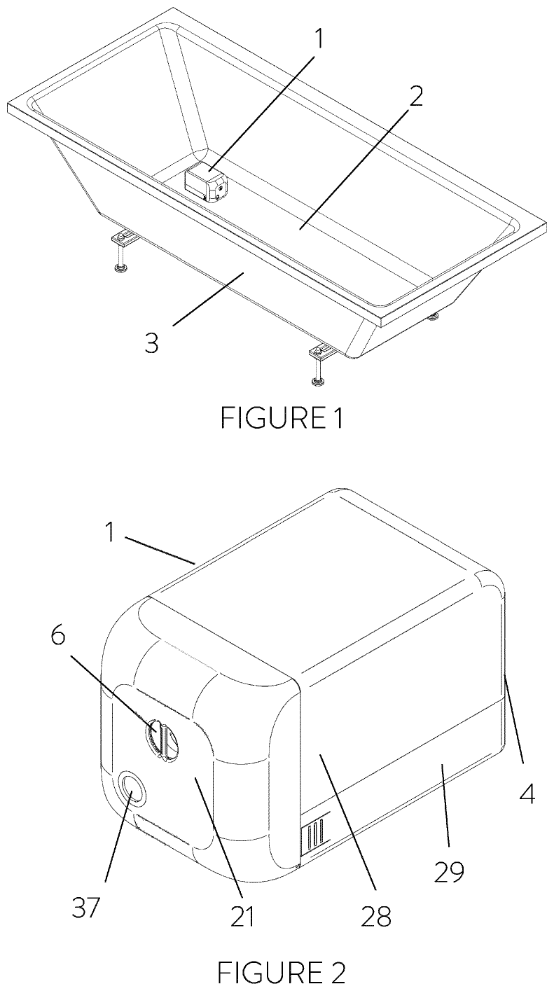

FIG. 1 is a perspective view of an apparatus configured according to the invention shown in a bathtub,

FIG. 2 is a front perspective view showing of the apparatus of FIG. 1,

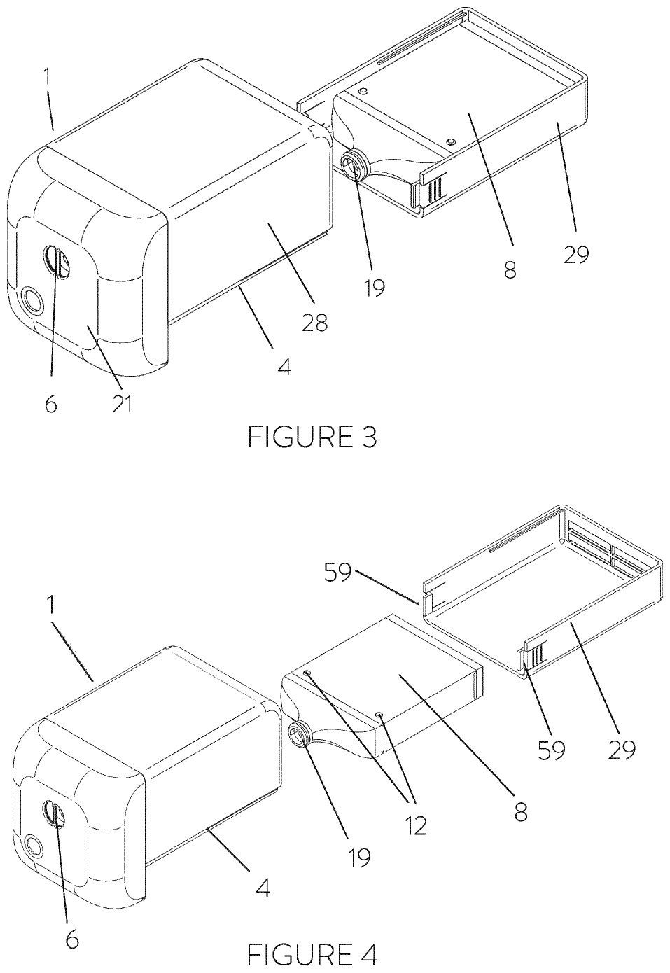

FIG. 3 is a perspective view of the apparatus of FIG. 1 showing a releasable or removal cartridge containing an electrolysis cell,

FIG. 4 is a perspective view of the apparatus of FIG. 3 showing the electrolysis cell removed from the cartridge,

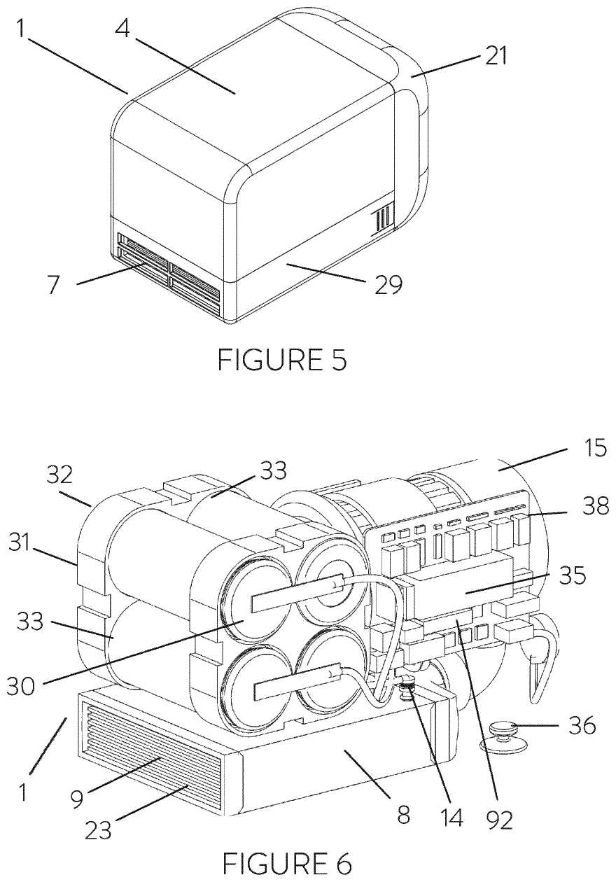

FIG. 5 is a rear perspective view of the apparatus of FIG. 1,

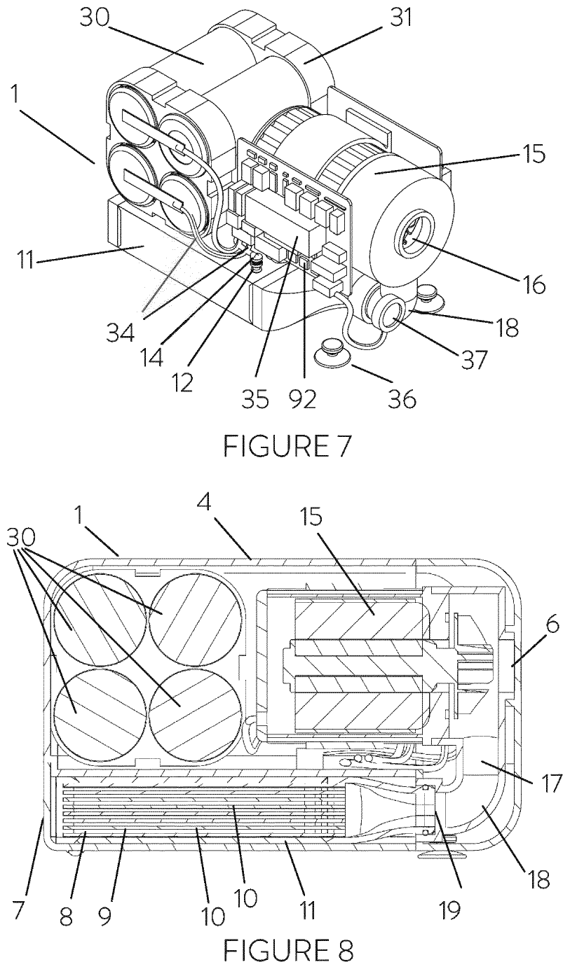

FIGS. 6 and 7 are front and rear perspective views of the apparatus of FIG. 1 with the housing removed,

FIG. 8 is a side sectional view of the apparatus of FIG. 1,

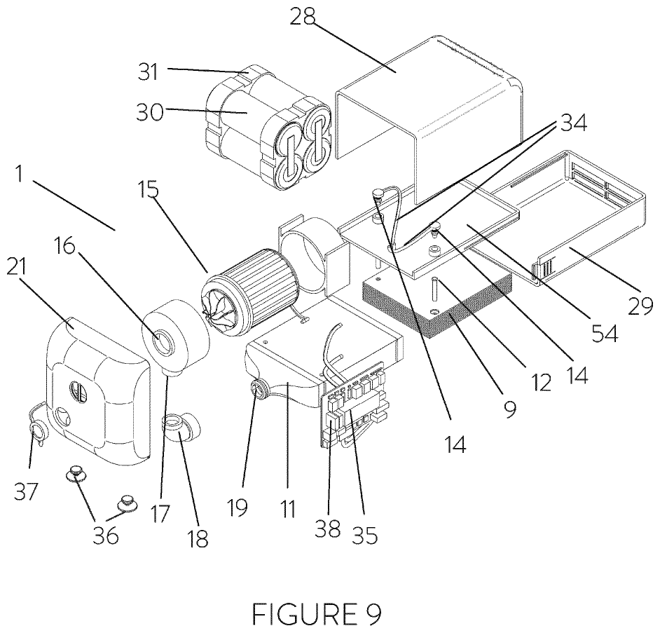

FIG. 9 is an exploded view of the apparatus of FIG. 1,

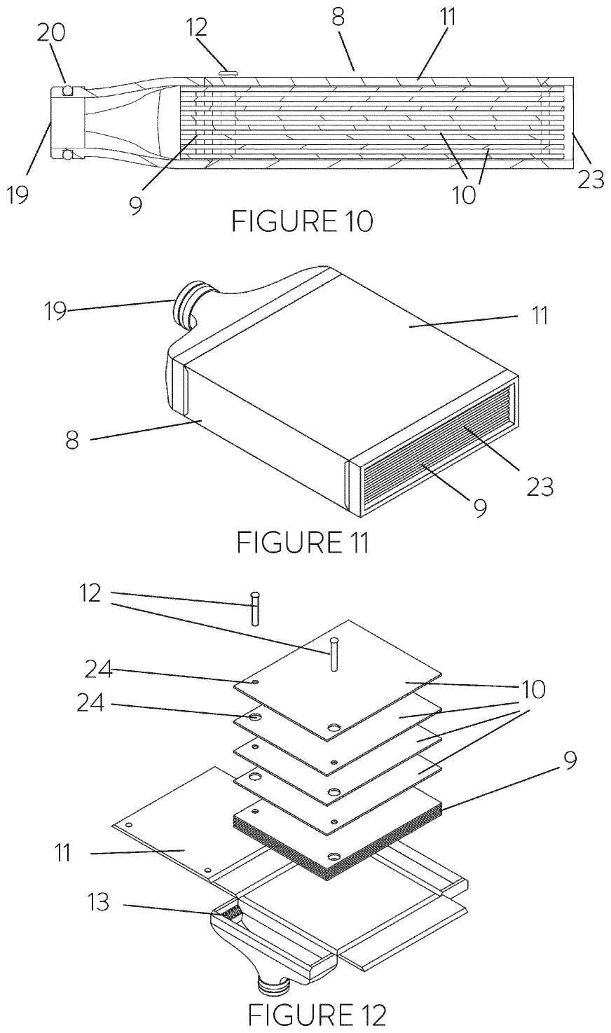

FIG. 10 is a side sectional view of the electrolysis cell of FIG. 3,

FIG. 11 is a perspective view of the electrolysis cell of FIG. 10,

FIG. 12 is an exploded view of the electrolysis cell of FIG. 10,

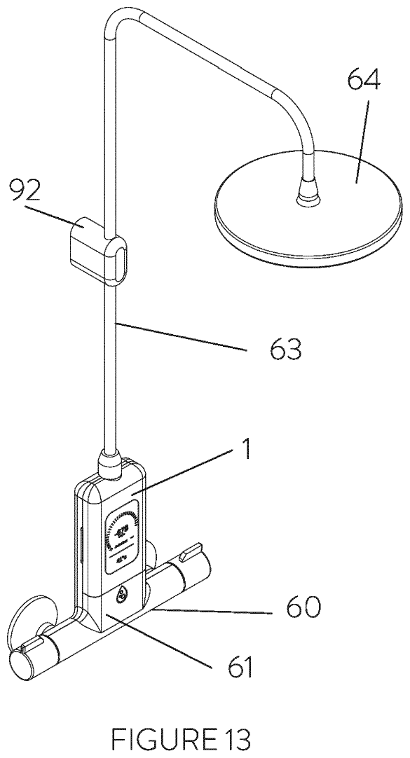

FIG. 13 is a perspective view of an apparatus configured according to a further embodiment of the invention integrated in a water flow configuration provided as a shower system,

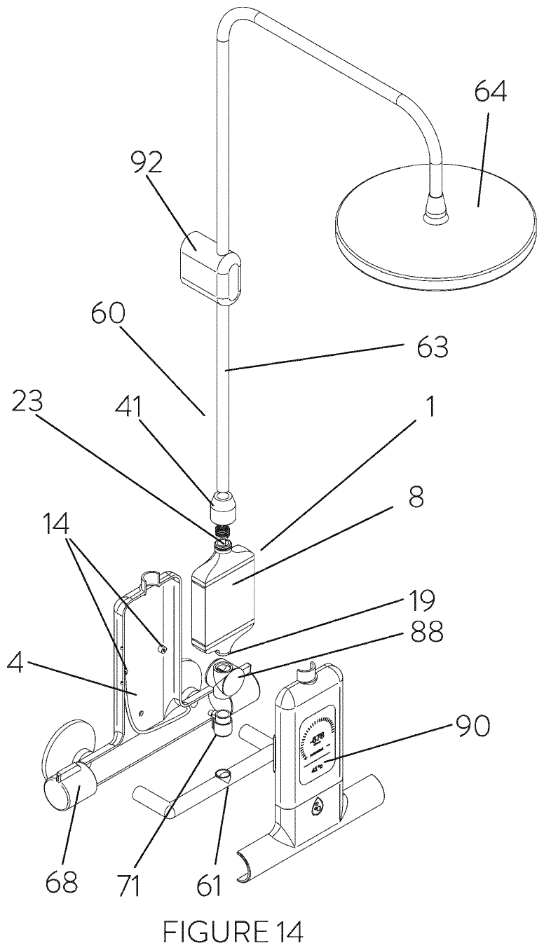

FIG. 14 is an exploded view of the apparatus of FIG. 13,

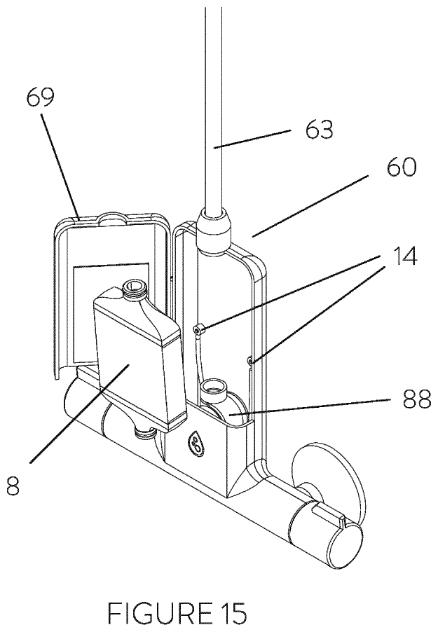

FIG. 15 is a perspective view showing a releasable or removal cartridge containing an electrolysis cell of the apparatus of FIG. 13,

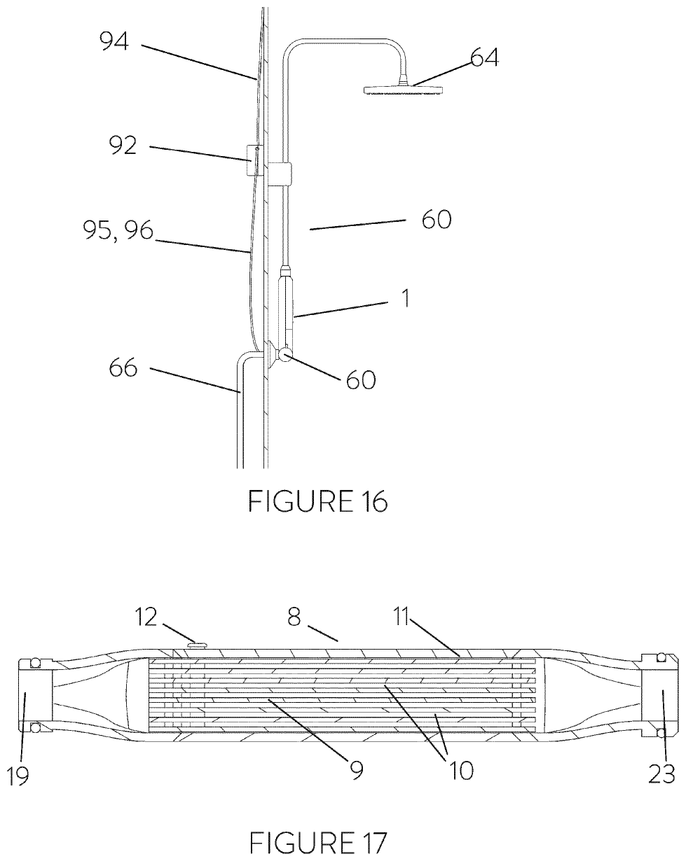

FIG. 16 is a diagrammatic of the apparatus of FIG. 13 showing electrical connections through a wall to a power control unit (PCU),

FIG. 17 is a side sectional view of the electrolysis cell of FIG. 15,

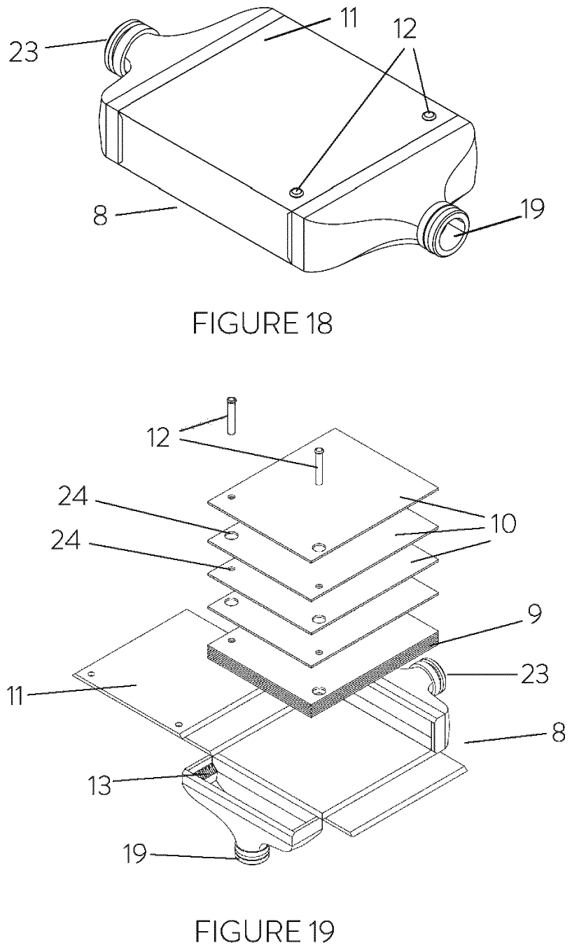

FIG. 18 is a perspective view of the electrolysis cell of FIG. 15,

FIG. 19 is an exploded view of the electrolysis cell of FIG. 15,

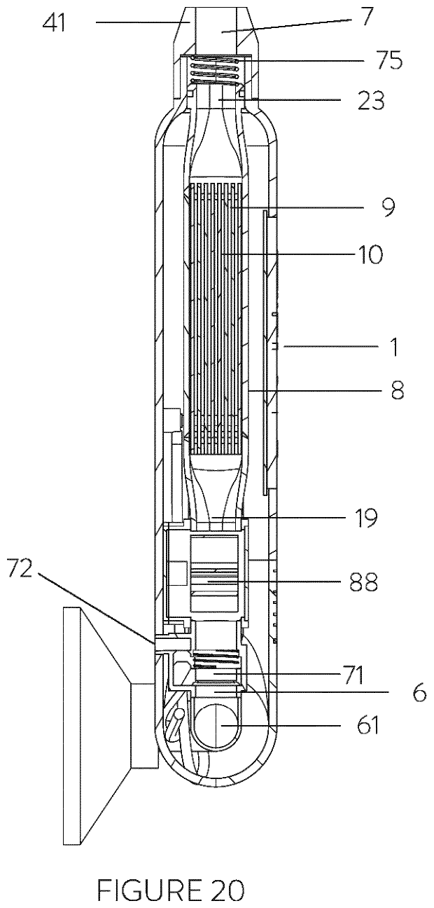

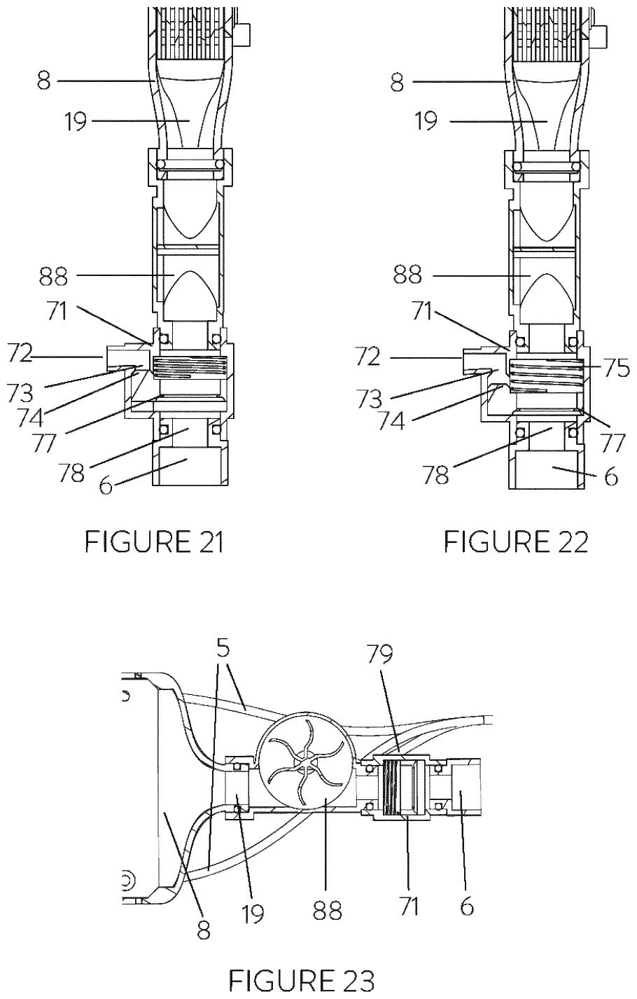

FIG. 20 is a sectional view of the apparatus of FIG. 13,

FIGS. 21 and 22 show the operation of a water drainage valve of the apparatus of FIG. 13,

FIG. 23 is a sectional view showing a flow meter of the apparatus FIG. 13,

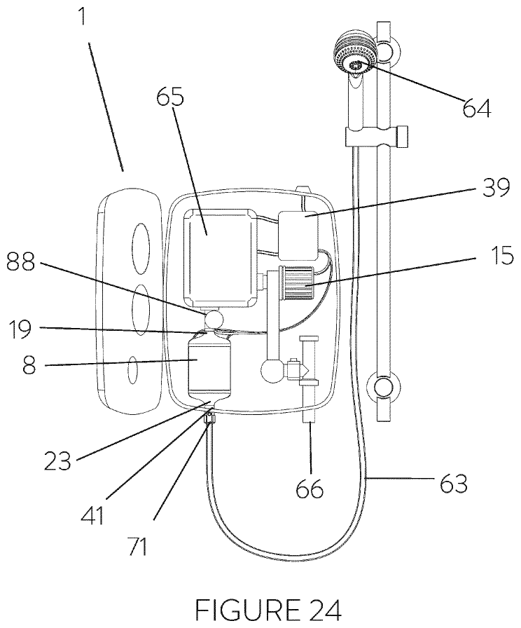

FIG. 24 is a diagrammatic of the apparatus of FIG. 13 fitted to an electric shower system,

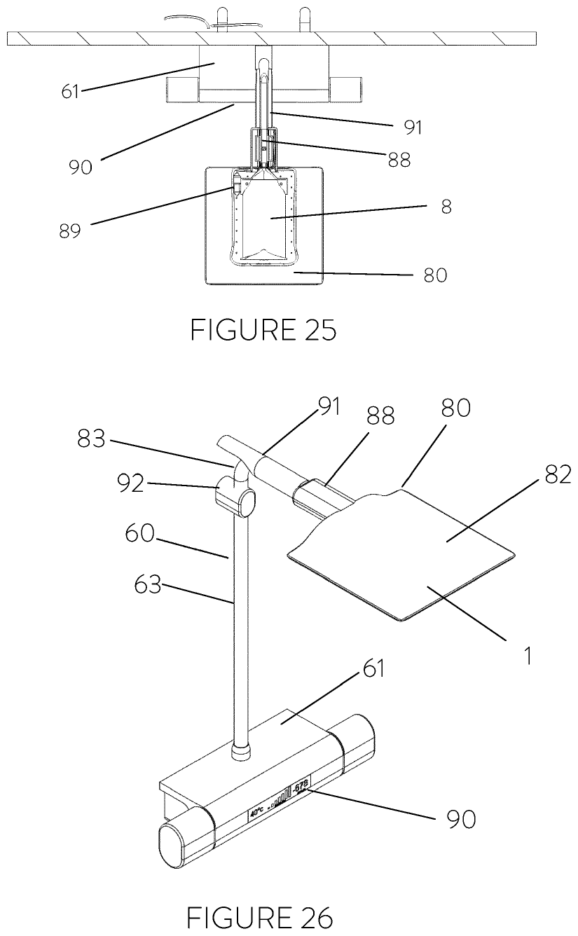

FIG. 25 is a top view of a showerhead and shower system incorporating the apparatus according to FIG. 13,

FIG. 26 is a perspective view of the shower head and shower system of FIG. 25,

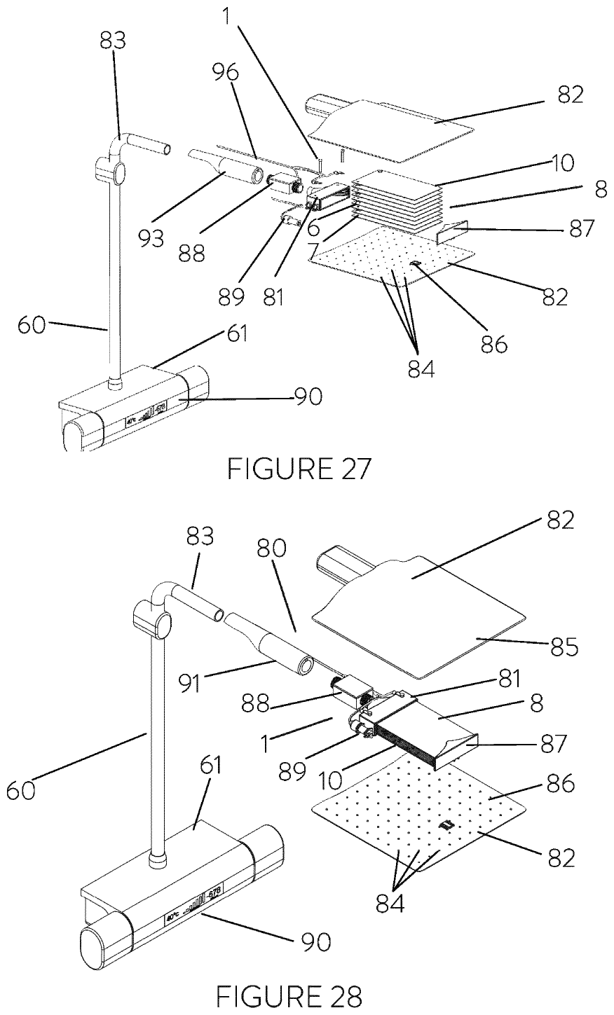

FIGS. 27 and 28 are exploded perspective views of the shower head and shower system shown in FIG. 25,

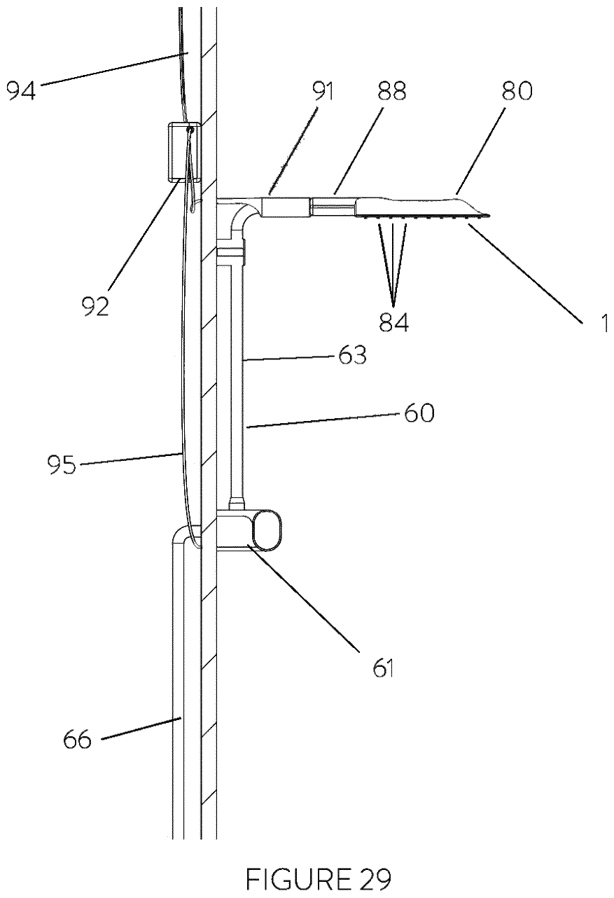

FIG. 29 is a diagrammatic of the shower system and showerhead of FIG. 25 further showing electrical connections through a wall to power control unit (PCU),

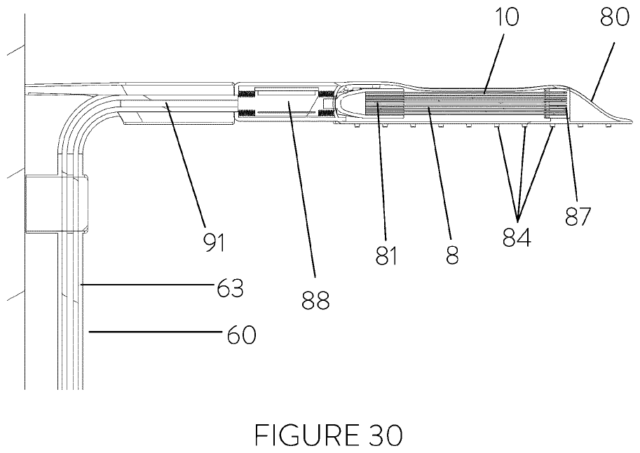

FIG. 30 is a side sectional view of the showerhead shown in FIG. 25,

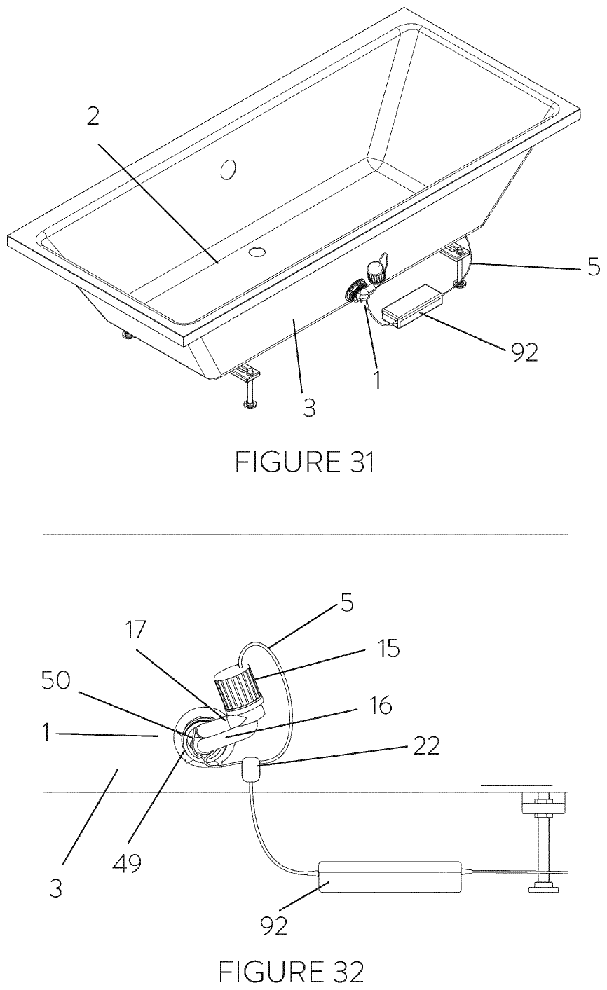

FIG. 31 is a diagrammatic of the apparatus according of the invention fitted to a wall of a bathtub,

FIG. 32 is a diagrammatic of the outer wall surface wall showing the apparatus of FIG. 31 fitted to an outer wall of the bathtub,

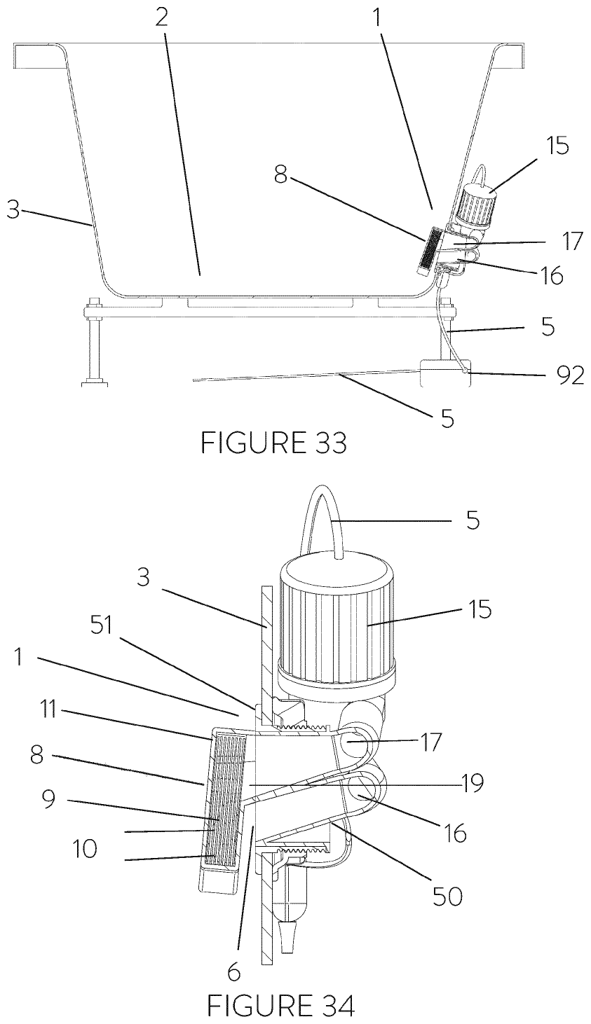

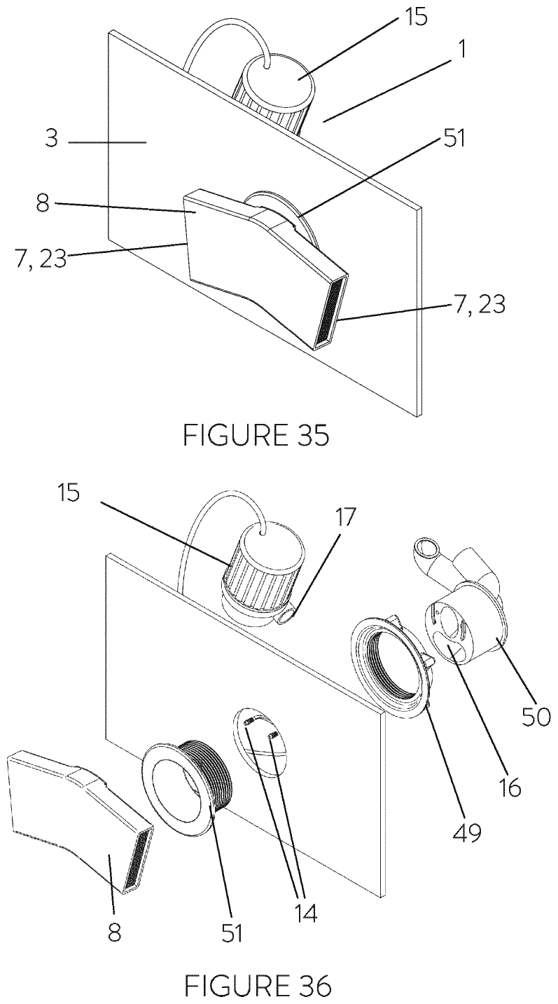

FIGS. 33 to 35 are further detailed views of the apparatus of FIG. 31,

FIG. 36 is an exploded view of the apparatus of FIG. 31,

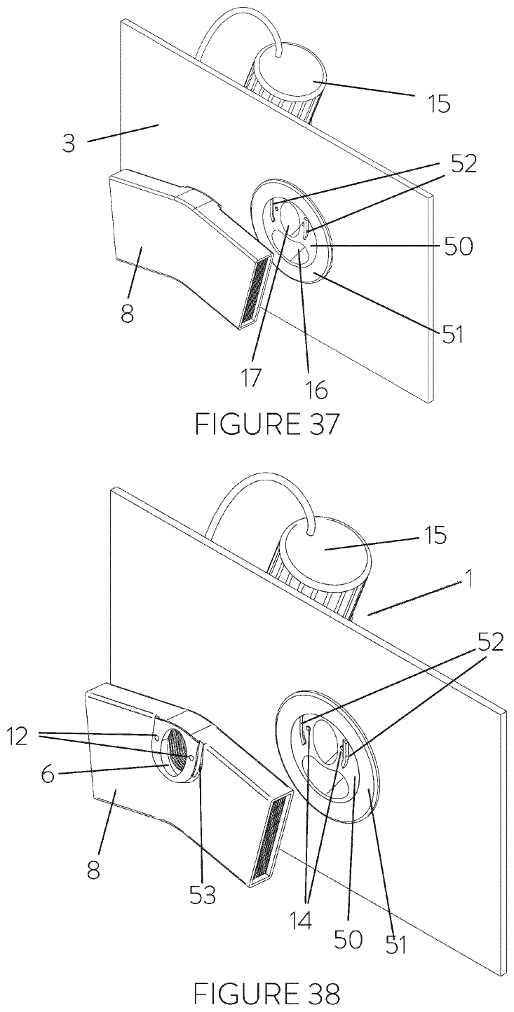

FIGS. 37 and 38 are views of the water pump outlet and inlet of the apparatus of FIG. 31,

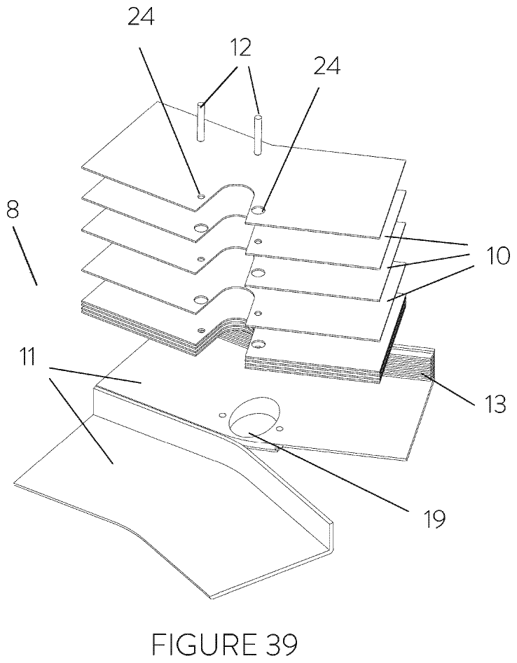

FIG. 39 is an exploded view of the electrolysis cell of the apparatus of FIG. 31,

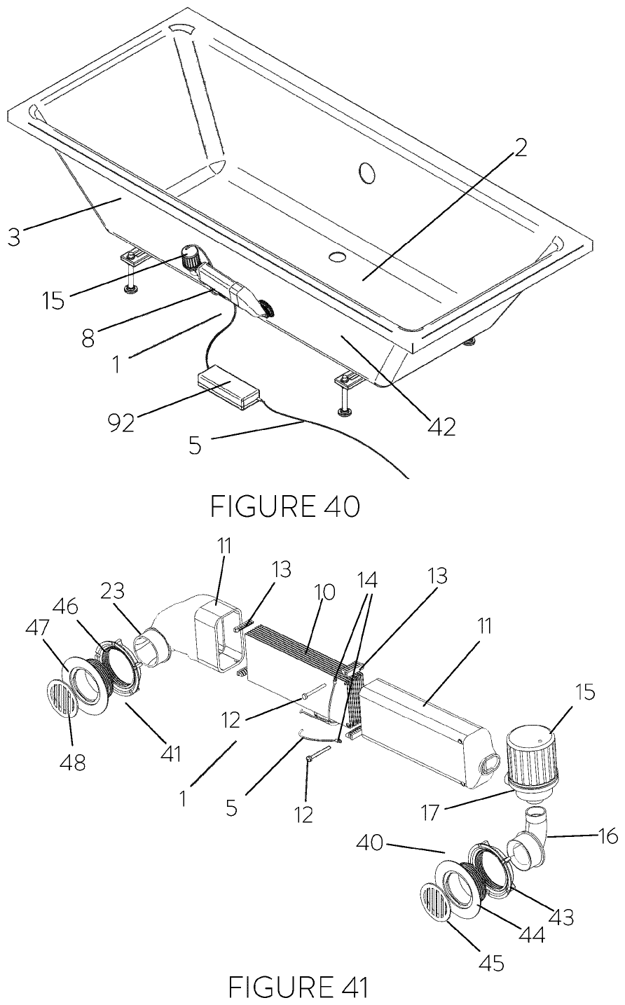

FIG. 40 is a perspective view showing an embodiment of the apparatus according to the invention fitted to or built into a wall surface of a bathtub,

FIG. 41 is an exploded view of the apparatus shown in FIG. 40,

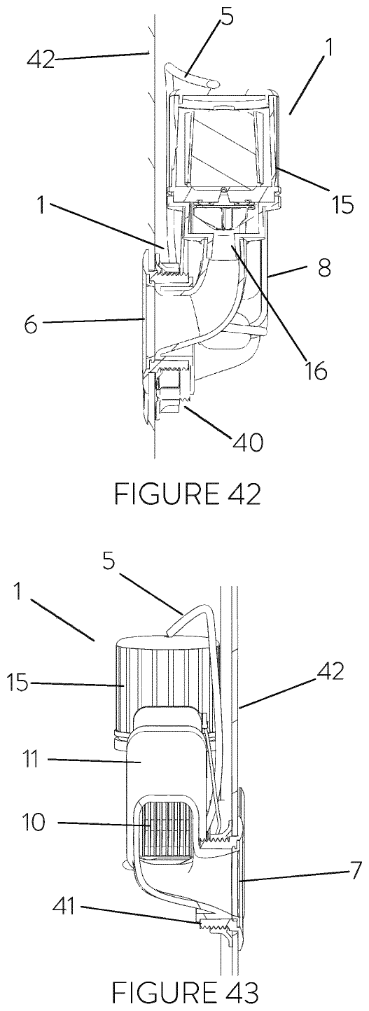

FIG. 42 is a side sectional view of the inlet connection of the apparatus shown in FIG. 40,

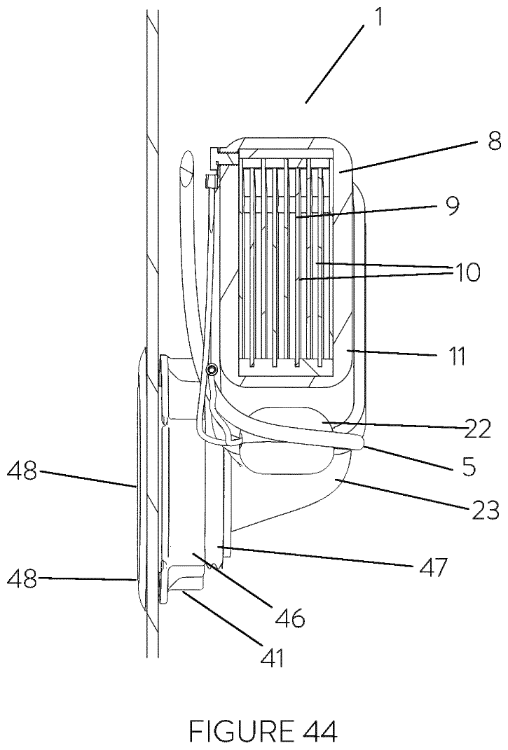

FIGS. 43 and 44 are side sectional views of the outlet connection of the apparatus shown in FIG. 40,

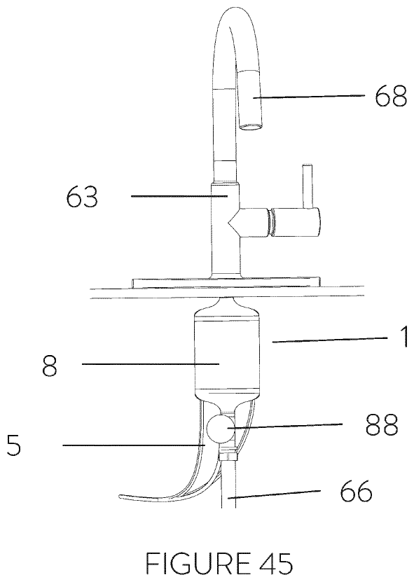

FIG. 45 is a sectional view of the apparatus incorporated for use in a drinking water system,

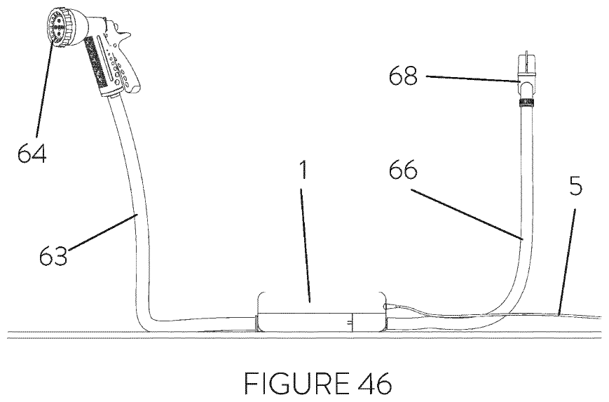

FIG. 46 is a perspective view showing an embodiment of the apparatus according to the invention in a further system with a shower or hose head to a tap,

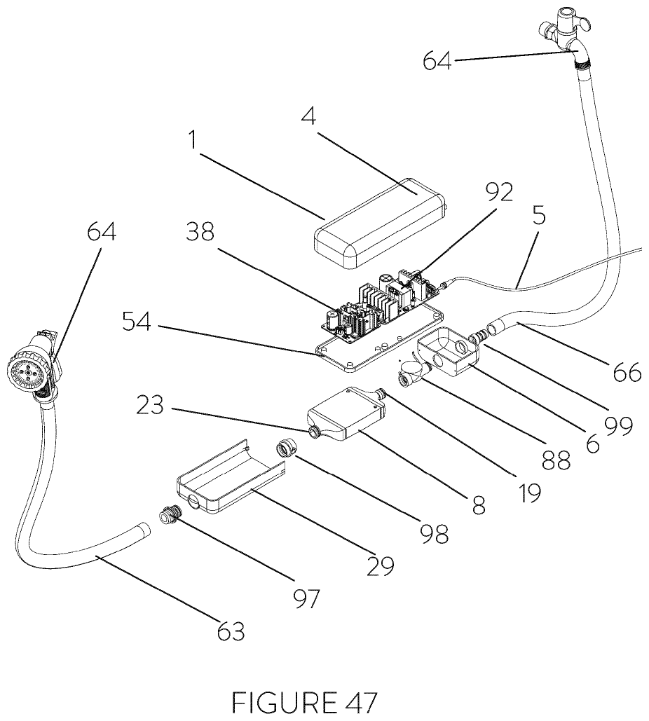

FIG. 47 is an exploded view of the apparatus of FIG. 46,

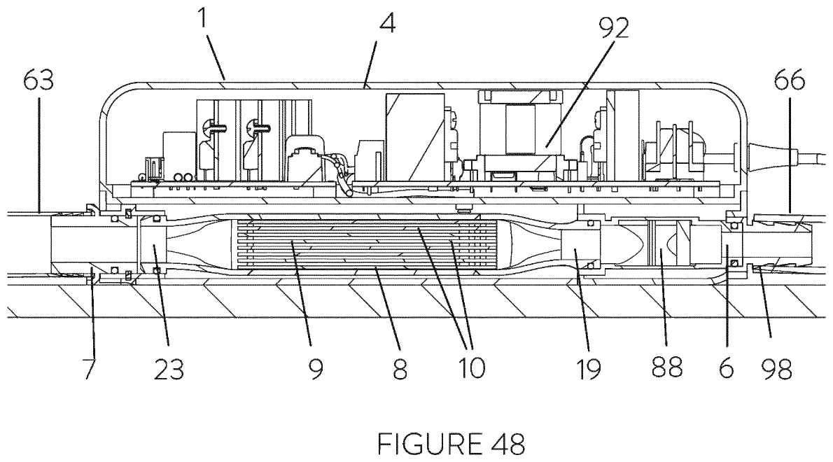

FIG. 48 is a sectional view of the apparatus of FIG. 46,

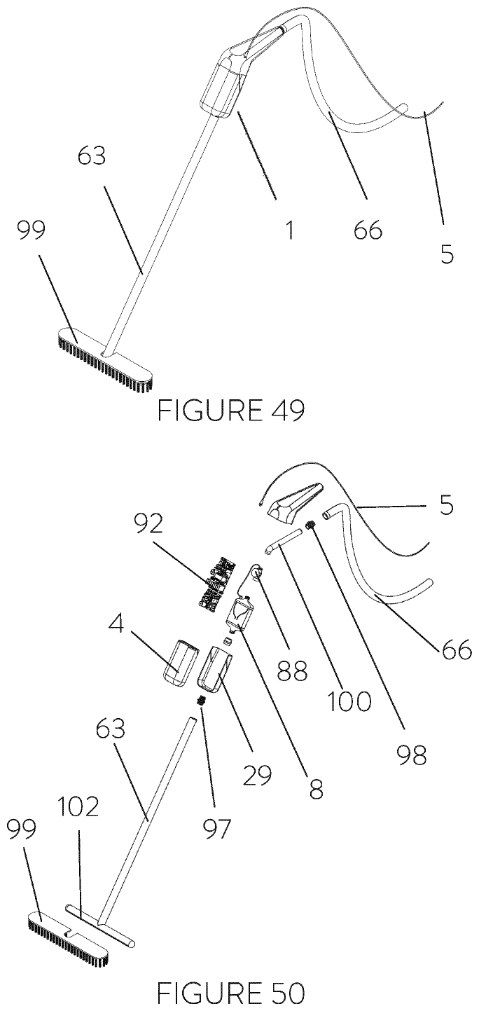

FIG. 49 is a perspective view showing an embodiment of the apparatus according to the invention in a further flowing water system with a shower/brush head coupled to a water supply tap,

FIG. 50 is an exploded view of the configuration of FIG. 49, and

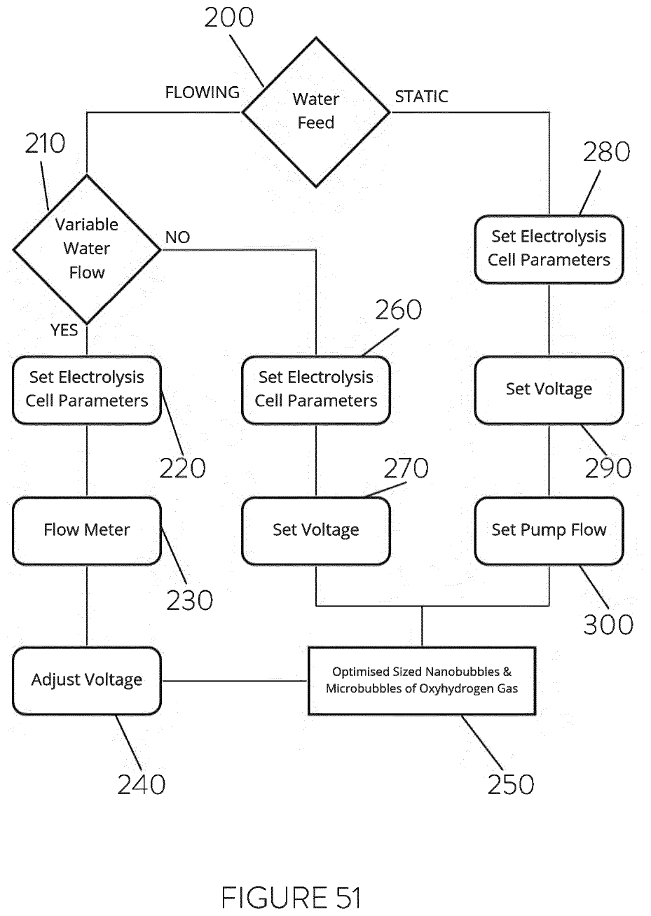

FIG. 51 is a flow diagram shows steps in a method according to the invention.

The present invention relates an apparatus for generating and delivering microbubbles and nanobubbles of hydrogen gas, oxygen gas and/or oxyhydrogen gas in water. Although reference in the following will be made to the apparatus being implemented to deliver microbubbles and/or nanobubbles in a bathtub containing bath water, in shower arrangements, and in drinking water this should in no way be seen as limiting. For example, the invention has utility in a variety of other applications comprising, but not limited to H₂ drinking water systems (animals, poultry and humans), aquaponic farming, water irrigation systems, wastewater treatment, washing systems, pet washing and many more.

It will also be understood that nanobubbles have diameters of less than about 1 micron/micrometre in size and microbubbles generally are defined as have diameters of less than about 100 microns (μm, micrometres).

Referring to the drawings, and initially to FIGS. 1 to 12, there is shown an apparatus, indicated generally by the reference numeral 1, for generating and delivering microbubbles and/or nanobubbles of hydrogen gas, oxygen gas and oxyhydrogen gas in water, which in the instance shown, is a reservoir of water, indicated generally by the reference numeral 2, provided as bath water contained in a bathtub 3.

However, although the water reservoir 2 is shown as a bathtub containing bath water it will be understood that this is by way of example only and that such a reservoir may be provided as water in any form of container such as a hot tub, footbath, spa bath, plunge pool, swimming pool, spa bath with integrated jets or the like and that reference to a bathtub should not be seen as limiting.

The apparatus 1 shown is contained in a housing 4 configured to be submersible in the bath water 2 and in the embodiment shown is adapted for battery powered operation.

The housing 4 comprises a top portion 28 to cover the pump and the battery, a front portion 21 having a housing inlet 6 and a removable releasable cartridge 29 for the electrolysis cell 8. The cartridge 29 has snap fit using a releasable catch 59 into a complementary receiver of the front portion 21 so as to be removable by a user to access and replace the electrolysis cell 8 within the electrode housing 11. The pump and battery 30 are fixed to a base plate 54.

The apparatus 1 housing comprises a housing inlet 6 for receiving a flow of water from the water reservoir or water supply 2 and a housing outlet 7 for delivering water comprising the microbubbles and nanobubbles of hydrogen gas, oxygen gas and/or oxyhydrogen gas into the bath water 2. An electrolysis cell, indicated generally by the reference numeral 8, is provided in the apparatus 1, and comprises electrodes, indicated generally by the reference numeral 9, in an electrode housing 11 to generate hydrogen and oxygen gas on the surfaces thereof to form nanobubbles and/or microbubbles of hydrogen gas, oxygen gas and/or oxyhydrogen gas from water 2 received via the housing inlet 6.

In the instance shown, the electrodes 9 are provided as an electrode stack configured to perform electrolysis on the water 2. The electrode stack comprises a plurality of spaced apart electrode plates 10 disposed such that the water flows between and over surfaces of the electrode plates 10 from the housing inlet 6 to the housing outlet 7 of the apparatus 1. The electrode plates 10 may optimally be spaced about 1 mm apart although it will be understood that this range is given by way of example only and that alternative spacings between the electrode plates are possible. The electrode plates 10 are thus arranged in the electrolysis call 8 so that the water flowing through the electrode stack is never more than a defined distance from an electrode 10 as it flows through the electrode housing 11.

The electrodes 10 are disposed within the electrode housing 11 such that water received at the housing inlet 6 flows through an electrolysis cell inlet 19 over the electrodes 10 to shear microbubbles and nanobubbles of hydrogen gas, oxygen gas and/or oxyhydrogen gas into the water flow and through the electrolysis cell outlet 23. The electrodes 10 are arranged to provide a laminar flow of water through the apparatus from the housing inlet 6 through the electrolysis cell inlet 16 across surfaces of the electrodes 10 within the electrode housing 11 to the electrolysis cell outlet 23 and out of the apparatus 1 via housing outlet 7.

Also shown is a water pump means 15 operable to draw water 2 into the apparatus 1 through the housing inlet 6 and to pump water 2 through the electrolysis cell 8 to the housing outlet 7 for delivery into the bath water 2.

A control unit 35 is operable to control and provide power to control the voltage applied to the electrolysis cell 8 and the water pump means 15 to pump water at a predetermined velocity through the electrolysis cell to control the average size of the nanobubbles and/or microbubbles generated, and the water flow at the predetermined velocity optimally shears the generated nanobubbles and/or microbubbles from the electrodes 10 into the water flow and through the housing outlet 7 of the apparatus 1.

The water pump means 15 is shown as a battery powered pump, however it may in alternative embodiments be provided as gravity feed pump or a pump powered from a mains electrical supply. The water pump 15 may be housed in the housing 4 of the apparatus 1 or provided adjacent to the electrolysis cell 8 depending on the application. In the instance shown, and by way of example only, the pump means 15 may be a 12-24V water pump operable to pump approximately between 2 to 12 litres of water per minute through the apparatus 1. It will however be understood that the configuration for a pump may be adapted as required to pump any volume of water, such as 50 litres or more water per minute through the apparatus 1 to achieve the desired water velocity and is dependent on the electrolysis cell configuration. Such a typical configuration may comprise

Accordingly, each application requires a water flow to optimise the size of the nanobubbles and microbubbles of hydrogen, oxygen and/or oxyhydrogen gas generation. The volume of generation is determined by three factors, 1. The Electrolysis Cell, 2 The voltage applied, 3 The velocity of the water flow.

By way of an example, the electrolysis cell comprises electrodes of a specific dimension, such as 70 mm by 80 mm providing a total area of 5,600 mm². Having 10 of these electrodes in an electrode stack provides a total surface area of reaction (SAR) of 100,800 mm². The performance of the electrolysis cell is further determined by the electrode material type and finish. For example, the average electrical resistivity of Nickel is 69.3 nΩ·m, Molybdenum is less at 53.4 nΩ·m, and Platinum is 105 nΩ·m. Therefore, the voltage applied to the electrolysis cell is generally in the range of 12V to 24V though may be higher or lower depending on the specific setup requirements. The distance between the electrode plates is another performance parameter of the electrolysis cell configuration.

If the flow rate is variable for a fixed electrolysis cell configuration, then the average gas bubble size produced will also be variable. Therefore, to optimise the generation of desired gas bubbles the electrolysis cell parameters should be configured according to the specific application and approximate flow rate.

Alternatively, the flow rate may be calculated prior to the installation of the apparatus so that the electrolysis cell parameters and voltage are configured for each installation.

To reduce corrosion and oxidation on the anode of non-noble metal electrodes a pulsed electric signal is applied.

Each electrode plate 10 in the stack is a cathode or an anode and the plates 10 are arranged in the stack to alternate in sequential order between being a cathode plate 10 and an anode plate 10.

As shown in FIG. 12, the cathode and anodes plates 10 are connected by an arrangement of holes, pins and spacers. In the instance shown alternate hole sizes are punched through the respective anode and cathode plates 10 and a corresponding channel 24 of the same size is formed in a spacer 13. A pin 12 is inserted through the holes formed in the plates 10 and spacer 13 to connect the anode plates together within a first spacer 13 and the cathode plates together with a second spacer 13. Further spacers 13 may also be provided as required or as desired. Thus, as an example, one 3.0 mm pin connects cathode plates together yet does not make any connection with the anodes as its hole size is bigger at 5 mm. The opposite then happens on the alternative side. A plastic spacer is used to keep the electrodes apart and a hole also extends through the spacers to allow the pin to connect the anodes on one side and cathodes on the other side.

Also shown is a water pump means 15 operable to draw water 2 into the apparatus 1 through the housing inlet 6 and to pump water 2 through the apparatus 1 to the housing outlet 7 for delivery into the bath water. The water pump means 15 is shown as an electrically powered pump, however it may in alternative embodiments be provided as gravity feed pump. The water pump 15 may be housed in the housing 4 of the apparatus 1, or provided adjacent to the electrolysis call 8 depending on the application. In the instance shown, and by way of example only, the pump means 15 is a 12V water pump operable to pump approximately between 2 to 20 litres of water per minute through the apparatus 1. It will however be understood that the configuration for a pump may be adapted as required to pump any volume of water, such as 50 litres or more water per minute through the apparatus 1 according to the desired velocity of water flow through the electrolysis cell 8.

A junction cable box 22 houses all electrical cables used to power and control the operation of the pump 15 and to the voltage applied to the electrolysis cell 8 and other components of the apparatus 1, such as the flow meter 88 when used.

The water pump means 15 comprises a pump inlet 16 through which water is drawn into the pump 15 and a pump outlet 17 via which water is moved through the electrolysis cell 8 and out of the housing outlet 7. The pump means 15 is connected to the electrolysis cell 8 by a pump outlet coupling, indicated generally by the reference numeral 18, that connects to an electrolysis cell inlet 19 operable to direct water flow from the outlet 17 of the pump to water entry apertures between the electrode plates 10. The water entry and exit apertures are provided between the electrode plates 10 to direct the flow of water across surfaces of the electrode plates 10 and through the electrolysis cell 8 to the electrolysis cell outlet 23. The water entry and exit apertures are provided at ends of the electrode plates 10.

The water pump means 15 may be arranged to draw water into the electrode housing 11 such that water received at the housing inlet 6 flows over the electrodes 10 to displace the microbubbles and nanobubbles of hydrogen gas, oxygen gas and oxyhydrogen gas formed at the electrodes 10 into the water flow and out of the housing outlet 7 of the apparatus 1 into the bath water 2. Furthermore, the housing inlet 6 and electrodes 10 are arranged such that the direction of flow of water through the housing inlet 6 and across the electrodes 10 and out of the housing outlet 7 of the apparatus 1 is substantially planar. The water flow through and along surfaces of the electrodes 10 shears the microbubbles and nanobubbles of hydrogen gas, oxygen gas and/or oxyhydrogen gas generated at the electrodes 10 and out of the apparatus 1 relatively quickly thereby preventing them from coalescing to a larger size, which would cause them to be eventually displaced from the electrodes 10 and to float to the top of the bath water and burst. By pumping water in a laminar flow at a desired optimal velocity across the electrodes 10 the contact time between the water 2 and electrodes 10 is optimised which avoids the formation of larger bubbles.

As shown in this embodiment, the apparatus 1 further comprises an arrangement of batteries 30 that are seated in one or more battery holders 31 located within the housing 4. In the instance shown a battery holder 31 may be configured for placement adjacent to the pump means 15. The battery holder 31 may comprise one or more chambers 32 for holding the one or more batteries 30 in positions as required at or adjacent to the pump means 15 within the housing 4. Additional battery holders 31 comprising seats 33 are also provided. A control unit 35 is coupled via electrical cables 34 to the electrical connectors 14 which connect to pins 12 to the electrolysis cell 8. Suction pads for securely fastening the apparatus 1 to a surface of the bath 3 are provided together with a charging port 37 for the batteries 31.

In a further embodiment of the present invention, the apparatus 1, rather than being powered by battery means may alternatively or additionally, be powered by connection to a power supply.

With reference to FIGS. 31 to 44, the apparatus 1 may be adapted for connection or retrofitting or being built into a side wall of a bathtub 3. Accordingly, and with reference now to FIGS. 31 to 44, the apparatus 1 is shown connected to the side wall of the bathtub 3. Reference numerals used in relation to like parts of the apparatus 1 shown in FIGS. 1 to 8 are also used in FIGS. 31 to 44.

In the embodiment shown, the electrolysis cell 8 is provided on an inner wall of the bathtub 3, and the water pump 15 and control unit 38 are coupled to the electrolysis cell and provided on an outer wall of the bathtub 3. In the configuration shown, the outlet 23 of the electrolysis cell 8 is bi-directional into the bathtub 3 giving a greater distribution of nanobubbles and microbubbles throughout the bathtub 3. The electrolysis cell 8 is removable from housing 11 at then end of use.

Pump 15 is operable to draw water into the pump inlet 16 from the bathtub 3 via water inlet 6 and through pump outlet 17 to the electrolysis cell 8 which is fully submerged in bath water 2 of the bathtub 3. A water inlet/outlet housing 50 together with an inlet/outlet locking nut 49 and locking plate 51 securely attach the components together through the wall of the bathtub 3. Flange 53 of the electrolysis cell housing 11 lock into receivers 52 provided in the locking plate 51.

The electrolysis cell 8 is configured to operate at a voltage set by the power control unit 92 according to the configuration of the electrodes 10 in the electrolysis cell 8, comprising the surface area of reaction of the electrolysis cell, and electrode type and distance between the electrodes 10 of the electrolysis cell 8.

The power control unit 92 is operable supply power to control the water pump means 15 to pump water at a predetermined velocity through the electrolysis cell 8 to control the average size of the nanobubbles and/or microbubbles generated, and the water flow at the predetermined velocity shears the generated nanobubbles and/or microbubbles from the electrodes 10 into the water flow and through the outlet 7 of the apparatus 1. Power contact pins 14 are electrically coupled to the electrode pins 12.

In the instance shown in FIGS. 41 to 44 the apparatus if provided on an outer wall of the bath tub 3. In the embodiment shown the apparatus 1 further comprises attachment means comprising an inlet connector, indicated generally by the reference numeral 40, and an outlet connector 41 for connecting the apparatus 1 to an external surface of side wall 42 of the water reservoir bathtub 2 filled with water. The inlet and outlet connectors 40, 41 each extend through spaced apart apertures in the side wall 42 of the bathtub 2 such that water from the bathtub is drawn into the housing inlet 6 of the apparatus 1 via the inlet connector 40 and microbubbles and nanobubbles of hydrogen gas, oxygen gas and oxyhydrogen gas displaced from the electrodes 10 into the water flow through the apparatus 1 are directed from the housing outlet 7 of the apparatus 1 and into the water in the reservoir water through the outlet connector 42.

The inlet connector 40 comprises a locking plate 44, locking nut 43 and grille plate 45 which are operable to connect with the fluid coupling 18 of the apparatus 1 via the aperture formed in the bathtub wall 42 to securely couple the housing inlet 6 of the apparatus 1 to the bathtub 3. In this way bath water flows into the apparatus 1 via the inlet connector 40 through the housing inlet 6. The outlet connector 41 also comprises a locking plate 47, locking nut 46 and grille plate 48 which connect to the electrolysis cell outlet 23 to secure the housing outlet 7 of the apparatus 1 to the bathtub wall 42 so that microbubbles and nanobubbles of hydrogen gas, oxygen gas and oxyhydrogen gas formed at the electrodes 10 may move out of apparatus 1 via the outlet connector 41 and into the bathwater contained in the bathtub 3.

The apparatus 1 shown comprises drainage means operable to allow water remaining in the apparatus 1 to drain when the water reservoir is emptied. In the instance shown the drainage means is self-draining and water may flow out of the apparatus 1 under force of gravity.

According to FIGS. 13 to 29 the apparatus 1 may be adapted for connection or placement in a shower unit. The shower may be a standard shower, a shower fitted in a bathtub, an electric shower or a power shower operable to heat water using a heated water reservoir provided between a mains water inlet and an outlet of the shower.

Shown is a shower unit 60 in which the apparatus 1 has been installed to receive water from the shower water mixer 61 of the shower unit 1. That is, the apparatus 1 receives water directly after the hot and cold water received from the plumbed water supply has been mixed by the water mixer 61. In the embodiment shown the apparatus 1 further comprises attachment means 41 for connecting the apparatus 1 to the shower unit 60.

A flow control means 88 is provided in the variable water flow of the shower unit 60 at the electrolysis cell inlet 19 and is operable to determine the rate of flow of water to thereby determine the voltage to apply to the electrolysis cell 8.

The outlet connector 41 connects the electrolysis cell outlet 23 to the main water outlet conduit or pipe 63 of the shower 60 leading to the shower head 64. Accordingly, water passes from the mains supply taps and through the shower mixer 61, through the housing inlet 6 of the apparatus and passes over the electrode plates 10 of the electrolysis cell 8. Pressure from the mains water supply may act as a water pump means to pump water through the electrolysis cell 8 to shear the nanobubbles and microbubbles of hydrogen gas, oxygen gas and oxyhydrogen gas formed at the electrodes 10 into the water flow and out of the housing outlet 7 of the apparatus 1 via the outlet connector 41 as shower water.

A control unit 39 is operable to adjust voltage to the electrolysis cell 8, whereby the amount of the voltage adjustment is made according to the determined rate of flow of water to control the average size of the nanobubbles and/or microbubbles generated, and wherein the flow of water shears the generated nanobubbles and/or microbubbles from the electrodes 10 into the water flow and through shower outlet 64.

In the embodiment shown the electrolysis cell 8 is accessible via a sealable door of the housing 4. Power contact pins to the electrodes 10 are also shown.

The apparatus 1 further comprises a user interface panel 90 operable to display parameters of the water flow, comprising one or more of: ORP reading, water temperature and water flow rate. The user interface panel 90 may be provided as required or desired by a shower user so for viewing the display parameters. Although shown mounted on adjacent the shower mixer 61 is not limiting. For example, the user interface panel 90 may be integrated into a wall unit, provided on a device or in some other way that facilitates the user experience.

The power control unit 92 is provided to determine the optimum DC power output to the electrodes to generate the optimum gas output from the electrodes to provide the optimum or maximum −ORP (negative ORP) value. The control unit 92 may also regulate and control the functions of the apparatus 1.

A wiring assembly module 91 is coupled to a power supply, which may be mains supply or battery, to supply power to the electrodes 10, flow meter 88, and other electrical aspects of the apparatus 1. Also shown is electrical supply wire 94, which provides AC power from an electrical supply to the control unit 92, electrical supply wire 95 operable to supply electrical power to the shower user interface display panel 90 for displaying temperature and ORP readings, and electrical supply wires 96 for supplying power to the electrolysis cell 8, flow meter 88 and optional ORP sensor means 89, which also optionally includes a temperature sensor means to determine the temperature of water flowing out of the showerhead 64.

As shown in FIGS. 20 to 23, the apparatus 1 comprises a water drainage valve 71 to allow water to drain from the electrolysis cell 8 when the flow of water from the water supply stops.

The water drainage valve 71 is closed by the flow of water from the water supply through the inlet and opens when the flow of water from the water supply stops allowing water to drain from the electrolysis cell 8 through the drain valve outlet 72. In operation water flows from the mains water supply through the housing inlet 6 and in through the valve inlet 78 in normal use. This water flow causes a valve head 74 to seal against a valve seat 73 causing the drainage valve 71 to close preventing water flow from the electrolysis cell 8 out through the drain valve outlet 72. The water flow when running is operable to engage the lip 77 which pushes the valve head 74 up to close against the valve seat 73 to thereby close the drain valve outlet 72 preventing water from flowing therethrough. Conversely, when water flow from the supply stops the valve head 74 drops and moves away from the valve seat 73 which provides an opening though which water drains out of the electrolysis cell 8 and apparatus 1. This prevents stagnant water from remaining in the apparatus 1 comprising the electrolysis cell 8 causing corrosion and damage to the electrodes 10. Wired connection 79 is shown to the flow meter 88 to sense the rate of flow of water from mains supply into the apparatus 1. A spring fitting 75 is provided between the outlet 7 of the apparatus and connectors 41.

As shown in FIG. 24, the shower 60 may be an electric shower comprising a heating element 65 through which mains water passes from a mains water inlet 66 and is pumped by pumping means 15 through the apparatus 1 to the outlet pipe 63 and out of the shower head 64. The inlet connector 40 couples the housing inlet 6 of the apparatus 1 to the heating element 65, and outlet connector 41 connects the water outlet pipe 63 to the housing outlet 7 of the apparatus 1 such that water pressure from the water pump means 15 pumps water through the electrolysis cell 8 to shear the nanobubbles and microbubbles of hydrogen gas, oxygen gas and/or oxyhydrogen gas formed at the electrodes 10 into the water flow which moves out of the housing outlet 7 of the apparatus 1 to the shower head 64 as shower water containing the nanobubbles and microbubbles of hydrogen gas, oxygen gas and/or oxyhydrogen gas. An optional flow control means 88 is also shown.

The power control unit 92 is operable to adjust voltage to the electrolysis cell 8, whereby the amount of the voltage adjustment is made according to the determined rate of flow of water to control the average size of the nanobubbles and/or microbubbles generated, and wherein the flow of water shears the generated nanobubbles and/or microbubbles from the electrodes 10 into the water flow and through shower outlet 64.

FIGS. 25 to 29 show the apparatus 1 disposed in a showerhead 80 of the shower system 60. In such an embodiment the apparatus 1 further comprises an attachment means provided as a support bracket 87 for connecting the apparatus 1 within a housing 82 of the showerhead 80. In the instance shown the housing 82 comprises a cover 85 and outlet plate 86 having outlet holes 84 of the showerhead 80. The housing for the showerhead 80 operates as a housing for the electrodes in the present embodiment.

An inlet connector 81 for fluid connection of the housing inlet 6 of the apparatus 1 to a water inlet 83 of the shower head 80 is provided and water flow received from the water inlet pipe 83 flows through the inlet connector 81 through the electrodes 10 of the electrolysis cell 8 to the housing outlet 7 of the apparatus 1 and exits the showerhead 80 through the outlet holes 84.

The apparatus 1 further comprises an inline flow meter 88 positioned and operable to measure water flow rate into the showerhead 80. As shown, the inline flow meter 88 is disposed at the inlet connector 83 of the showerhead 80.

Also provided is an optional oxidation reduction potential (ORP) sensor means 89 to measure ORP of the water flow out of the electrolysis cell. The ORP sensor means 89 is disposed such that it may sense ORP values at the housing outlet 7 of the electrolysis cell 8, and more specifically at the exit apertures provided between the electrodes 10. In the instance shown, the ORP sensor means 89 is mounted to the inlet connector 81 such that it extends into the follow of water from the exit apertures between the electrodes 10 to measure ORP the value of the water flow out of the electrolysis cell 8.

FIG. 45 is an arrangement by which the apparatus 1 is connected in a domestic water tap to provide drinking water. In the embodiment shown, the housing inlet 6 of the apparatus 1 is connected to a water supply inlet pipe 66. The apparatus 1 further comprises an inline flow meter 88 positioned and operable to measure water flow rate into the apparatus 1. As shown, the inline flow meter 88 is also provided. A voltage adjustment is made according to the determined rate of flow of water to control the average size of the nanobubbles and/or microbubbles generated, and wherein the flow of water shears the generated nanobubbles and/or microbubbles from the electrodes 10 into the water flow and through the drinking water dispense head or tap 68.

FIGS. 46 to 48 show an arrangement of the apparatus integrated with a shower or hose head 64 connected to a water tap 68. Connectors 97, 98 couple the apparatus 1 to a water supply inlet pipe or hose conduit 66 between the tap 68 and inlet to the apparatus 1. Outlet pipe or hose conduit 63 is coupled to the head 64.

FIGS. 49 and 50 show the apparatus 1 integrated with a brush head 99 connected to a water tap 68. Connectors 97, 98, 100, 101 couple the apparatus 1 to a water supply inlet pipe or hose conduit 66 between the tap 68 and inlet to the apparatus 1. Outlet pipe or hose conduit 63 having an outlet 102 is coupled between the outlet 7 of the apparatus 1 and the brush head 99.

The present invention may be further illustrated with reference to FIG. 51 which is a flow diagram showing steps in a method according to the invention.

At step 200, water feed is determined as being static, such as in a water reservoir embodiment, or flowing, such as in a shower embodiment.

At step 210 water is determined as being a variable flow or not. If water flow is variable then at step 220, electrolysis cell parameters are set and, at step 230, a flow meter flow is used to determine the water flow at the inlet of the apparatus.

At step 240 voltage to the electrolysis cell is adjusted, whereby the amount of the voltage adjustment is made by a control unit according to the determined rate of flow of water and electrolysis cell parameters to control the average size of the nanobubbles and/or microbubbles generated, and at step 250, the flow of water shears the generated nanobubbles and/or microbubbles from the electrodes into the water flow.

Conversely, if the water flow at step 210 is not variable flow then the electrolysis cell parameters are set at step 260 and voltage applied to the electrolysis assembly is set at step 270 by a control unit according to the rate of flow of water and electrolysis cell parameters to control the average size of the nanobubbles and/or microbubbles generated, and at step 250, the flow of water shears the generated nanobubbles and/or microbubbles from the electrodes into the water flow.

If at step 200 the water supply is static then at step 280 electrolysis cell parameters are set, at step 290 voltage to the electrolysis assembly is set, and at step 300, a control unit controls a water pump means to pump water at a predetermined velocity through the electrolysis cell to control the average size of the nanobubbles and/or microbubbles generated, and at step 250, the water flow at the predetermined velocity shears the generated nanobubbles and/or microbubbles from the electrodes into the water flow and through the water outlet of the apparatus.

Aspects of the present invention have been described by way of example only and it should be appreciated that additions and/or modifications may be made thereto without departing from the scope thereof as defined in the appended claims.

1. An apparatus for generating and delivering nanobubbles and/or microbubbles of hydrogen gas, oxygen gas and/or oxyhydrogen gas, the apparatus including:
an electrolysis cell configured to receive a flow of water,
wherein the electrolysis cell includes
a stack of electrodes formed by a plurality of spaced apart electrode plates having electrode plate surfaces that extend in the direction of movement of water flow through the electrolysis cell, and in which spaces between the electrode plates provide water entry apertures and water exit apertures for the flow of water between respective ends of the electrode plates,
the electrode plates are configured to perform electrolysis on the water flow through the electrolysis cell to generate the hydrogen gas, oxygen gas and/or oxyhydrogen gas on the electrode plate surfaces thereof from the water flow to form the nanobubbles and/or microbubbles, and
an electrode housing containing the stack of electrodes, the electrode housing includes
a housing inlet for receiving the flow of water, and the water entry apertures are configured to receive the flow of water from the housing inlet, and
a housing outlet configured to receive the flow of water from the water exit apertures,
in which the electrolysis cell is configured so that the flow of water is from the housing inlet through the water inlet apertures and across the electrode plate surfaces and through the water outlet apertures and out of the apparatus through the housing outlet, and the housing inlet, the housing outlet and the electrode plates are configured to generate an unimpeded laminar flow of water across the electrode plate surfaces within the electrolysis cell and out of the housing outlet as a laminar flow of water, and
wherein the unimpeded laminar flow of water through the electrolysis cell controls the average size of and coalescence of nanobubbles and/or microbubbles generated on the electrode plate surfaces and shears the generated nanobubbles and/or microbubbles from the electrodes plate surfaces out of the apparatus in the laminar flow of water.

2. The apparatus of claim 1, in which the apparatus further includes water pump means to draw water flow as a flow of water through the electrolysis cell, and a control unit to control the water pump means is configured to pump water at a predetermined velocity through the electrolysis cell to control the average size of and coalescence of the nanobubbles and/or microbubbles.

3. The apparatus of claim 1, in which the apparatus further includes flow control means to determine the rate of flow of water through the housing inlet, and a control unit operable to adjust voltage applied to the electrolysis cell according to the rate of flow of water to control the average size of and coalescence of nanobubbles and/or microbubbles.

4. (canceled)

5. The apparatus of claim 1, in which the housing inlet, the housing outlet and the electrode plates are configured in substantially the same plane.

6. The apparatus of claim 1, in which the electrode housing is configured as a cartridge that is removably connected within the apparatus

7. (canceled)

8. (canceled)

9. (canceled)

10. (canceled)

11. The apparatus of claim 1, in which the electrode plates in the stack of electrodes are spaced between 0.4 mm to 2.5 mm apart.

12. (canceled)

13. (canceled)

14. The apparatus of claim 1, further including battery power means.

15. The apparatus of claim 1, further including means for connection to a mains power supply.

16. (canceled)

17. (canceled)

18. (canceled)

19. (canceled)

20. (canceled)

21. (canceled)

22. (canceled)

23. (canceled)

24. The apparatus of claim 1, including a water drainage valve to allow water to drain from the electrolysis cell when the flow of water stops, in which the water drainage valve is closed by the flow of water and opens when the flow of water stops allowing water to drain from the electrolysis cell.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. The apparatus of claim 2 configured in an arrangement with a water reservoir, whereby the housing inlet of the apparatus is configured to receive the flow of water flow from the water reservoir.

48. (canceled)

49. (canceled)

50. The apparatus of claim 3 configured in an arrangement with a shower system, whereby the housing inlet of the apparatus is configured to receive the flow of water from a water supply coupled to the shower system.

51. (canceled)

52. (canceled)

53. The apparatus of claim 3 configured in a shower head, whereby the housing inlet of the apparatus is configured to receive a flow of water from a shower system coupled to the shower head.

54. (canceled)

55. (canceled)

56. The apparatus of claim 3 configured in an arrangement with one or more of a potable drinking water tap, pet washing system, watering system, brushing system or cleaning system, whereby the housing inlet of the apparatus is configured to receive the flow of water from a water supply coupled to the one or more of a potable drinking water tap, pet washing system, watering system, brushing system or cleaning system.

57. (canceled)

58. (canceled)

59. A method for generating and delivering nanobubbles and/or microbubbles of hydrogen gas, oxygen gas and/or oxyhydrogen gas, the method including steps of:
providing an electrolysis cell configured to receive a flow of water, wherein the step of providing an electrolysis cell includes
configuring a stack of electrodes with a plurality of spaced apart electrode plates having electrode plate surfaces that extend in the direction of movement of water flow through the electrolysis cell, and in which spaces between the electrode plates provide water entry apertures and water exit apertures for the flow of water between respective ends of the electrode plates,
configuring the electrode plates to perform electrolysis on the water flow through the electrolysis cell to generate the hydrogen gas, oxygen gas and/or oxyhydrogen gas on the electrode plate surfaces thereof from the water flow to form the nanobubbles and/or microbubbles, and
providing an electrode housing to contain the stack of electrodes, configuring the electrode housing to include
a housing inlet in which the water entry apertures are configured to receive the water flow from housing inlet, and
a housing outlet configured to receive water flow from the water exit apertures,
arranging the electrolysis cell so that the flow of water is from the housing inlet through the water inlet apertures and across the electrode plate surfaces through the water outlet apertures and out of the apparatus through the housing outlet, and configuring the housing inlet, the housing outlet and the electrode plates to provide an unimpeded laminar flow of water across the electrode plate surfaces within the electrolysis cell and out of the housing outlet as a laminar flow of water, and
wherein the unimpeded laminar flow of water through the electrolysis cell controls the average size of and coalescence of nanobubbles and/or microbubbles generated on the electrode plate surfaces and shears the generated nanobubbles and/or microbubbles from the electrode plate surfaces out of the apparatus in the laminar flow of water.

60. The method of claim 59, including a step of providing water pump means to draw water flow through the electrolysis cell, and providing a control unit to control the water pump means, the water pump means is configured to pump water at a predetermined velocity through the electrolysis cell to control the average size of and coalescence of the nanobubbles and/or microbubbles.

61. The method of claim 59, including a step of providing flow control means to determine the rate of flow of water through the housing inlet, and providing a control unit to adjust voltage applied to the electrolysis cell according to the rate of flow of water to control the average size of and coalescence of nanobubbles and/or microbubbles.

62. The method of claim 59, including a step of configuring the electrode housing as a cartridge that is removably connected within the apparatus.

63. The method of claim 59, including a step of spacing the electrode plates in the stack of electrodes between 0.4 mm to 2.5 mm apart.

64. A shower unit including an apparatus for generating and delivering nanobubbles and/or microbubbles of hydrogen gas, oxygen gas and/or oxyhydrogen gas, the apparatus including:
an electrolysis cell configured to receive a flow of water, wherein the electrolysis cell includes
a stack of electrodes formed by a plurality of spaced apart electrode plates having electrode plate surfaces that extend in the direction of movement of the flow of water through the electrolysis cell, and in which spaces between the electrode plates provide water entry apertures and water exit apertures for the flow of water between respective ends of the electrode plates,
the electrode plates are configured to perform electrolysis on the flow of water through the electrolysis cell to generate the hydrogen gas, oxygen gas and/or oxyhydrogen gas on the electrode plate surfaces thereof to form the nanobubbles and/or microbubbles, and
an electrode housing containing the stack of electrodes, the electrode housing includes
a housing inlet to receive the flow of water, and the water entry apertures are configured to receive the water flow from the housing inlet, and
a housing outlet is configured to receive the flow of water from the water exit apertures,
in which the electrolysis cell is configured so that the flow of water is from the housing inlet through the water inlet apertures and across the electrode plate surfaces through the water outlet apertures and out of the apparatus through the housing outlet, and the housing inlet, the housing outlet and the electrode plates are configured to generate an unimpeded laminar flow of water across the electrode plate surfaces within the electrolysis cell and out of the housing outlet as a laminar flow of water, and
wherein the unimpeded laminar water flow through the electrolysis cell controls the average size of and coalescence of nanobubbles and/or microbubbles generated on the electrode plate surfaces and shears the generated nanobubbles and/or microbubbles from the electrode plate surfaces out of the apparatus in the laminar flow of water to a shower head of the shower system,
and the apparatus includes flow control means to determine the rate of flow of water through the housing inlet, and a control unit operable to adjust voltage applied to the electrolysis cell according to the rate of flow of water to control the average size of and coalescence of nanobubbles and/or microbubbles in the laminar flow of water.

65. The apparatus of claim 64, in which the electrode plates in the stack of electrodes are spaced between 0.4 mm to 2.5 mm apart.
